(19) United States
(12) Patent Application Publication
(10) Pub. No.: US 2019/0170896 A1
(43) Pub. Date: Jun. 6, 2019

(54) INDUCED NUCLEAR EXCITATION TRANSFER

(71) Applicant: IH IP Holdings Limited, St. Heilier (JE)

(72) Inventors: Peter L. Hagelstein, Carlisle, MA (US); Florian Metzler, Cambridge, MA (US)

(21) Appl. No.: 16/191,108

(22) Filed: Nov. 14, 2018

Related U.S. Application Data
(60) Provisional application No. 62/586,144, filed on Nov. 14, 2017.

(51) Int. Cl. G01V 5/00; G01T 3/00

(52) U.S. Cl. CPC G01V 5/0069; G01T 3/00

(57) ABSTRACT

An excitation transfer in a nuclear state is energetically induced. The excitation transfer may be induced by heating a structure to which a nuclear species is mechanically coupled. The heating may be applied as a triangular heat pulse. The heating may generate a stress effect in the structure. The stress effect may produce vibratory phonons. The excitation transfer may include up-conversion. The excitation transfer may include radioactive decay. The decay rate of a radioactive species may be increased to a rate higher than the natural half-life of the radioactive species. Energy may be harnessed from decay of the radioactive species. A decay product having industrial or medical use may be rapidly produced. The decay rate of the radioactive species may be lowered to reduce emissions for safe storage or transportation.

### CROSS-REFERENCE TO RELATED APPLICATION

This application claims the benefit of priority of U.S. provisional patent application No. 62/586,144, titled “TEMPERATURE CHANGE STIMULATION OF STRESS-INDUCED NUCLEAR EXCITATION,” filed on Nov. 14, 2017, which is incorporated herein in its entirety by this reference.

### TECHNICAL FIELD

The present disclosure relates to systems, methods, and processes for determining and utilizing controllable stimuli that prompt or affect nuclear excited states, nuclear processes, decay of radioactive nuclei, and energy transfer.

### BACKGROUND

Excess heat effects potentially emanating from stimulated nuclear regime processes in electrochemical cells have been previously reported. Efforts are being made to reconcile experimental findings with theories and models in nuclear physics and solid state physics and condensed matter physics. Under normal conditions when a nuclear reaction produces energy, the resulting energy is carried off as energetic nuclear radiation. The absence of energetic nuclear radiation accounting for the energies produced in experiments provides a barrier to understanding what goes on microscopically. Improvements are needed in systems and methods for determining and utilizing controllable stimuli that prompt or affect nuclear processes, decay of radioactive nuclei, and energy transfer.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

In at least one embodiment, a method is provided for energetically inducing an excitation transfer in a nuclear state. In at least one example, inducing an excitation transfer comprises energetically stimulating a sample using phonons. Energetically inducing an excitation transfer may include producing phonons using at least one laser. Energetically inducing an excitation transfer may include producing phonons using an electric current.

In at least one example, energetically inducing an excitation transfer includes diffusing solutes to produce phonons in at least one of alloys, solids, solutions, and condensed matter.

In at least one example, energetically inducing an excitation transfer comprises using ion beams to produce phonons.

In at least one example, energetically inducing an excitation transfer includes heating a structure to which a nuclear species is mechanically coupled. Heating the structure may include applying a heat pulse. In at least one example, heating the structure includes generating a stress effect in the structure. The stress effect may produce vibratory phonons.

In at least one example, the excitation transfer includes up-conversion.

In at least one example, the excitation transfer includes radioactive decay.

In at least one example, inducing the excitation transfer includes increasing the decay rate of a radioactive species to a rate higher than the natural half-life of the radioactive species. Energy from decay of the radioactive species may be harnessed. A decay product having industrial or medical use may be rapidly produced. Inducing the excitation transfer may lower the decay rate of a radioactive species to a rate lower than the natural half-life of the radioactive species. Lowering the decay rate of the radioactive species may include lowering emissions for safe storage or transportation.

According to at least one embodiment, a system includes: a support structure; a sample supported by the support structure; and a stimulus for energetically inducing, in the sample, an excitation transfer in a nuclear state.

In at least one example, energetically inducing an excitation transfer includes energetically stimulating the sample using phonons. Energetically inducing an excitation transfer may include heating the support structure to which a nuclear species in the sample is mechanically coupled.

The stimulus may include at least one laser, and energetically inducing an excitation transfer may include producing phonons using the at least one laser. The stimulus may include an ion beam that produces phonons.

In at least one example, heating the support structure includes applying a heat pulse. In at least one example, heating the support structure includes generating a stress effect in the structure. The stress effect may produce vibratory phonons.

In at least one embodiment, an excitation transfer in a nuclear state is energetically/mechanically induced. In at least one example, the excitation transfer is induced by heating a structure to which a nuclear species is mechanically coupled. Heating may be applied as a triangular heat pulse. The heating may generate a stress effect in the structure. The stress effect may produce vibratory phonons. In at least one example, excitation transfer causes up-conversion i.e. excitation of nuclear ground states or lower excited states to higher nuclear excited states via vibrations of the lattice (phonons) surrounding affected nuclei. The excitation transfer can cause higher nuclear excited states that induce beta decay or fission of affected nuclei. Energy may be harnessed from the resulting nuclear processes such as fission and nuclear decay. A decay product having industrial or medical use may be rapidly produced. Accelerated beta decay can cause conversion of affected nuclei to more useful and/or less hazardous nuclei. The decay rate of affected materials may be lowered to reduce emissions for safe storage or transportation.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1 is a schematic representation of an apparatus according to at least one embodiment.

FIG. 2 is a plot of temperature as a function of time and heater pulses.

FIG. 3 is a plot of time history of Sn Kα transitions.

FIG. 4. is a plot of the time history of Fe-57 14.4 keV gamma transitions.

FIG. 5 is a plot of the time history of Fe Kα transitions.

FIG. 6 is a plot of the incremental intensity of the Fe=57 14.4 keV gamma (dark circles) and Fe K-alpha x-ray (white circles) as a function of temperature.

FIG. 7 is a plot of the time history of Geiger counter counts.

FIG. 8 is a plot of counts as a function of channel for the NaI detector for the lowest 1000 channels.

FIG. 9 is a time plot of the NaI detector main peak channels 389-640.

FIG. 10 is a time history plot of the NaI detector escape peak channels 250-389.

FIG. 11 is a time history plot of the NaI detector low energy channels 85-160.

FIG. 12 is a time plot of the NaI detector high energy channels 640-1110.

FIG. 13 is an energy level scheme diagram for the decay of Co-57 to Fe-57.

FIG. 14 is a data spectrum showing counts versus energy.

FIG. 15 is a data plot showing counts versus time.

FIG. 16 is a plot of Geiger counter readings versus time.

FIG. 17 is a diagram representing an implementation according to at least one embodiment.

FIG. 18 is a plot of an X-ray spectrometer's 14.4 keV line's total counts over 12 days.

FIG. 19 is a plot of a Geiger counter's total counts over 12 days.

FIG. 20 is a time-resolved view of the 14.4 keV line in the decay of Co-57.

FIG. 21 is a plot of counts versus time.

FIG. 22A shows numerical results for coherent energy exchange of 1700 oscillator quanta between 100 two-level systems and an oscillator.

FIG. 22B show numerical results taken in conjunction with FIG. 22B.

FIG. 23, which illustrates level splitting at the level anticrossing as a function of the dimensionless coupling constant g, plots calculations for ΔE=11 ℏω₀, 21 ℏω₀, and 31 ℏω₀.

FIG. 24 is a plot showing a reproduction of a model and simulation.

FIG. 25 is an illustration of the decay of Co-57 according to the traditional picture.

FIG. 26 is an illustration of a first stage of the decay of Co-57 according to a subdivision picture.

FIG. 27 is an illustration of a second stage of the decay of Co-57 according to the subdivision picture.

FIG. 28 is another illustration of excitation transfer according to the subdivision picture.

FIG. 29 is an illustration of an array of dipole antennas that are in phase to form a collimated beam.

FIG. 30 illustrates a coherent process of excitation transfer from one state to one state or few states.

FIG. 31 illustrates an incoherent process of excitation transfer from one state to many states.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Unless described or implied as exclusive alternatives, features throughout the drawings and descriptions should be taken as cumulative, such that features expressly associated with some particular embodiments can be combined with other embodiments.

Recent implementations demonstrate the existence of a theoretically derivable phonon-nuclear coupling effect. The effect enables new engineering solutions in nuclear engineering, specifically for affecting nuclear excited states via lattice vibrations (phonons).

Following the observation of non-exponential decay in the Fe K-alpha and Fe-57 14.4 keV gammas in the May 20 implementation, quite a few subsequent implementations were carried out, most of which showed much smaller versions of the anomaly. In the Aug. 10 implementation we worked with thermal pulses implemented using a resistive heater, in the hope of increasing the anomaly as a result of increasing the dislocation velocity. We observed an increase in the emission on these lines correlated with the heater pulses, which demonstrates partial control over the anomaly. The slow decay of the anomaly following the heater pulses indicates that increased stress and subsequent creep contributes. The prompt response to the temperature change with incremental increase in emission roughly linear with temperature points to a stress effect instead of a dislocation mechanism. A reduction in emission for both transitions at early time in response to the clamp tightening was observed, in contrast to the May 20 implementation where an increase was seen. Anomalies associated with the harder gammas at 122 keV and 136 keV were seen in the time histories of a NaI detector, which is probably associated with time-dependent anisotropic emission.

1. Introduction

We recently reported observations of non-exponential decay in the Fe-57 14.4 keV gamma and the Fe Kα and Kβ x-rays from a steel plate on which a centimeter-sized spot of Co-57 was evaporated. The initial goal of the implementation was to see whether we could see a delocalization of the x-ray and gamma emission due to excitation transfer when the plate was driven by a transducer near 2 MHz. As discussed in our previous paper, we did not see this kind of excitation transfer effect, even when the transducer was driven at a peak power of more than 100 watts. Instead we saw an anomalous time dependence of the strong Fe-57 14.4 keV gamma and the Fe Kα and Kβ x-rays where the decrease in the emission over 11 days was much more than we expect given the 271.7 day half-life of Co-57. Exponential decay of the signal from the Sn Kα was seen consistent with the 271.7 day half-life of Co-57, which indicates that the Fe-57 136.5 keV excited state population is consistent with what we would expect if there is no modification of the beta decay of Co-57. The stress imposed on the steel plate in this implementation primarily impacted the lowest Fe-57 excited state at 14.4 keV.

In subsequent implementations we were able to see a weaker version of the effect. In the first implementation (the May 20 implementation) we observed an enhancement of the Fe Kα of about 20%, while in the first few subsequent implementations the strongest enhancement was about 2%. It was a mystery as to what was responsible for the large magnitude of the effect in the first implementation.

The exponential decay time of the enhancement in the first implementation was about 2.2×10⁵ seconds, or about two and a half days. We have seen considerable variability in this decay time, from a speedy ten hour decay when the clamps were placed close to the Co-57, to a much slower decay for the implementation under consideration in this work of about ten days for the initial transient.

Another major issue has to do with whether there is a cause and effect relation between whatever stimulation is applied, and the response of the strength of the x-ray and gamma emission. We concluded that the stimulation which caused the non-exponential decay in the first implementation was the tightening of the bolts which provides for pressure on the wood clamps attached to the steel plate. In subsequent implementations, non-exponential decay was found after the clamps were tightened, which is supportive of the conclusion.

Preferred is an implementation in which we see precisely the same response every time we do the same implementation. Sadly, this is not what we have seen in connection with replication attempts based on the bolt tightening approach. This is due in part to our having tested slightly different (or very much different) version of the implementation in response to various ideas put forth (as appropriate at the early stage of experimentation), and also in part to what appears to be real changes in the response of the sample. The development of a version of the implementation which is much more reproducible is of high priority, and this provides a major motivation for the discussion of the Aug. 10 implementation in this paper.

Various ways can be used to effect that shear stress could result in a force on linear dislocations inside the steel sample, which could result in the generation of THz vibrations when the dislocations move. THz phonons are preferred in connection with excitation transfer and up-conversion effects according to models that have been studied. The dislocation velocity in steel near room temperature increases significantly with increasing temperature. Consequently, we were motivated to try implementations in which the temperature is increased to see whether we might see an enhancement of the anomaly. The hope was that if we see an increase of the enhanced emission due to creep when the temperature is increased, and no enhanced emission when the creep has run its course, then we might conclude that the increase is consistent with a moving dislocation hypothesis.

2. Implementation Details

Following the discussion above, one of the goals of the implementation was to test whether the anomaly depends on temperature; and in particular whether it depends on temperature differently when the creep rate due to bolt tightening is high than when the creep rate is low. Because of this we wanted to work with clamps and bolts as in earlier implementations.

As mentioned above, we had found that the magnitude of the anomaly was in general smaller in our early tests following the May 20 implementation for reasons that were not clear to us. An implementation carried out in July where we had used the transducers had given a relatively strong effect, in contrast with implementations without the transducers seemed to give weaker versions of the effect. Consequently, one of our goals of the Aug. 10 implementation under discussion here was to work with a configuration “close” to the May 20 configuration, specifically including the transducer and gel (even though we had no plans to power up the transducer), and augmented with heaters.

For this test we moved the Geiger counter to a front-side position, in the hope of learning something about whether the emission is collimated or not. The scintillator/PMT x-ray detector discussed in our previous paper was at this time being used for a different implementation. In the meanwhile we had arranged the loan of an NaI detector which was looking at the back side at an angle.

2.1. Implementation Set-Up

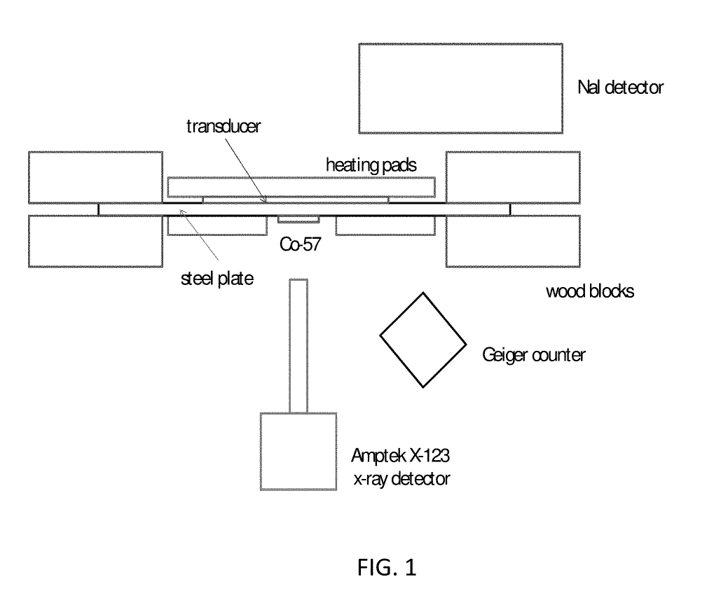

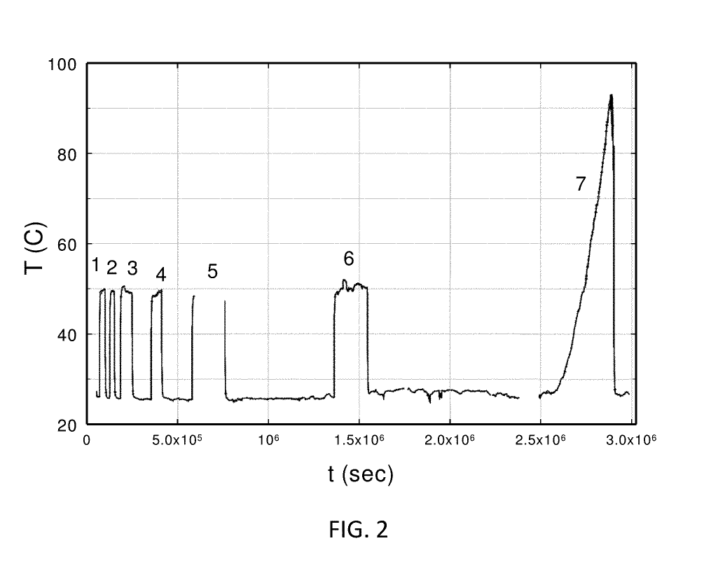

As represented in FIG. 1, the sample under test is a steel plate with Co-57 evaporated on the surface in a centimeter sized spot, which is on the bottom side in the implementation. The transducer and gel are attached to the steel plate on the top side, with the Co-57 underneath. Heating pads are attached both above and below the steel plate. Wood blocks are clamped onto opposite corners (here represented as sides) of the steel plate to induce stress. The Amptek X-123 x-ray detector views the Co-57 from below; the NaI detector (light green) views the sample from above, and the Geiger counter views the Co-57 from below and off to the side. The heating pads are tied to the plate and transducer both above and below.

2.2. Steel Plate and Co-57

The steel plate used in this experiment is the same one as in the May 20 experiment, and is described in our earlier paper. The plate has dimensions 3″×6″× 5/32″, it is made of low carbon steel (McMaster-Carr part number 1388K546).

We ordered 1000 mCi of Co-57 in the form of 57CoCl₂ in 0.1 M HCl in November, 2016, and used about 1/3 of it in the evaporation. We estimated roughly 200 mCi present at the beginning of the May 20 implementation, which would mean about 165 mCi at the beginning of the Aug. 10 run. The evaporated solution was covered and sealed with epoxy so that the radioactive Co-57 would stay in place.

2.3. Wood Blocks and Heater Pads

The steel plate is clamped using four pieces of plywood attached with long screws and nuts that were hand tightened prior to operation. We made use of silicone heating pads (part number A1109U) from Watlow, which can deliver up to 13 W at 20 volts.

2.4. Transducer and Gel

We made use of the same transducer and gel as were used in the May 20 implementation; however, there was no intention to drive the transducer in the Aug. 10 implementation. Instead we have observed that implementations in which the transducer and gel are present give a larger version of the anomaly, so in this implementation we included it to make the overall implementation somewhat closer to the May 20 implementation.

The transducer is a high power 1″×6.5″ piezo transducer rated for 1.95-2.07 MHz from PCT Systems Inc. The gel is the VersaSonic multipurpose high temperature ultrasonic couplant from ECHO Ultrasonics.

2.5. Amptek X-123 X-Ray Detector

We used the same Amptek X-123 Si-PIN detector with a 0.5 mil Be window and 6 mm² area as was used in the May 20 implementation. The gain setting was not changed since the May 20 implementation, so that the upper energy bin is near 28 keV, with 2038 bins.

2.6. NaI Detector

For detection of the harder gammas above 100 keV we used a Canberra NAIS 2×2 NaI(Tl) LED temperature stabilized scintillation detector. The NaI detector was above the sample and wrapped in foam. The Co-57 was on the bottom side of the steel sample facing the Amptek x-ray detector underneath aluminum mesh. The Gieger counter was under the aluminum mesh below a wood block.

3. Results: Amptek Spectra

In the May 20 implementation we saw a significant nearly 20% increase in the Fe K-alpha x-ray and Fe-57 14.4 keV gamma at early times, but in general a much smaller effect in subsequent implementations. The number of operational parameters is large, and each operational run takes a while, so over time we have been carrying out tests hoping to understand what is important in giving a big signal. In the Aug. 10 implementation we added the transducer and gel, not because we planned to drive MHz vibrations, but because we thought there might be a chance that the presence of the transducer and gel make a difference. We were also interested in testing whether raising the temperature would produce a stronger version of the anomaly.

3.1. Heater Pulses

Prior to the implementation we thought that it should be straightforward to apply relatively short heater pulses and test whether the anomaly was enhanced. If raising the temperature caused the dislocation velocity to increase, then we might expect more THz phonons to be present correlated with the higher temperature. If this worked, the thought was that we might be able to take less time for each implementation (progress has seemed slow since each implementation takes on the order of a week).

Consequently, we began with two short (8 hour) heater pulses labeled 1 and 2. Based on the response of the time histories monitored in real time during the implementation, it was clear that we needed longer heater pulses spaced further apart. This led to two subsequent intermediate (18 hour) heater pulses labeled 3 and 4. It became clear from the data that there was a long relaxation time associated with the anomaly following these heat pulses, so we decided to wait a bit and then try two longer (48 hour) heater pulses labeled 5 and 6. There was data loss in the temperature channel during pulse 5, but the input to the heaters were the same for these two pulses, so that we expect the temperature history during the time of the lost data of pulse 5 was basically the same as for pulse 6.

There was an especially long transient observed following pulse 6, so we delayed further pulses for a time, hoping that the plate would return to a quiescent state before further operation. For the last pulse 7 we worked with a slow triangular heater pulse, hoping to get information about the temperature dependence of the anomaly. In this case we decided to explore a higher temperature regime in the hope of seeing an even larger effect on the time histories.

3.2. Time History for the Sn K-alpha X-Ray

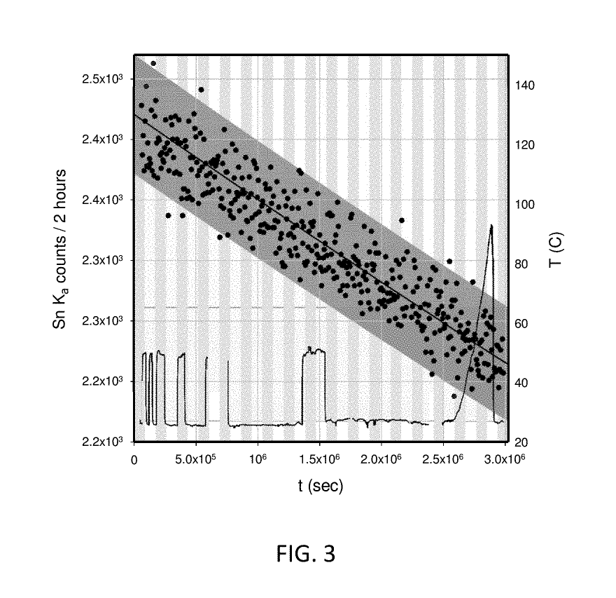

We begin with the time history for the Sn K-alpha x-ray which is photoionized by the harder gammas, and which showed no obvious deviation from exponential decay in the May 20 implementation. This line served as a control for the Amptek detector in that implementation, and we return to it in the Aug. 10 implementation for the same reason. The time history is shown in FIG. 3, which is a plot of time history of the Sn Kα transition (circles); exponential decay with 271.74 day half-life (black line); ±1σ error bars determined by the square root of the counts for the exponential decay (shaded region); and counts per 2 hour accumulation time indicated on the left axis. The temperature is shown in the bottom part of the plot (lower plot); with the temperature axis indicated on the right axis. The bottom time axis is in seconds; the alternating background bands show the duration of each day of the plotted time interval.

In FIG. 3, the emission is exponential with no obvious slow deviation present, and with no obvious changes when the heater pulses are present. Later on we consider direct measurements of the harder gammas with the NaI detector, where the number of counts is very much greater, and where we see an obvious but small non-exponential decay.

We estimated the noise at the 1σ level from the square root of the number of counts per two hour accumulation time, which in this case is about 2% of the number of counts. The increase seen by the NaI detector in the strongest peak channel is on the order of 2%, which would be obvious if present in the Sn K-alpha time history. When analyzed with a longer accumulation time in order to reduce the statistical error, the data shows a weak reduction at early time on the order of −0.2% with a corresponding relaxation time near 2.4×10⁶. All in all, this line decays essentially exponentially.

There does not appear an obvious correlation of the intensity on this line with the heater pulses.

3.3. Time History for the Fe-57 14.4 keV Gamma

In the May 20 implementation a strong non-exponential decay was seen on the Fe-57 14.4 keV gamma, where an enhancement of the emission was seen at early time. This provides us with motivation to examine the time history of this line in the Aug. 10 implementation.

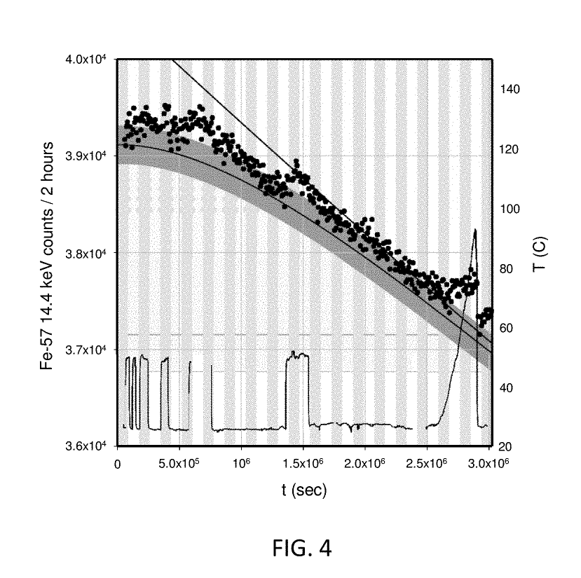

FIG. 4 is a plot of the time history of the Fe-57 14.4 keV gamma transition (circles); exponential decay with 271.74 day half-life (upper black line); empirical model (curve); ±1σ error bars determined by the square root of the counts for the empirical model (shaded band that follows the curve); and counts per 2 hour accumulation time indicated on the left axis. The temperature is shown in the bottom part of the plot (lower plot); with the temperature axis indicated on the right axis. The bottom time axis is in seconds; the alternating shaded background shows the duration of each day of the plotted time interval.

The time history for the 14.4 keV gamma is shown in FIG. 4. We see an obvious reduction (instead of an enhancement) in the emission at early time with a long relaxation time. An empirical model was fit to a subset of the data according to

$$ln I ( t ) = - \frac{t}{τ} + a + b {e}^{- t / {τ}_{b}} \qquad Equation ( 1 )$$

where the first term is associated with the Co-57 decay, and where the last describes the non-exponential decay. In this case the least squares fitting parameters associated with the slow non-exponential decay were found to be

b=−0.0353 τ_{b}=1.18×10⁶ sec Equation (2)

The signal in the absence of the anomaly according to this empirical model would be

$$ln {I}_{0} ( t ) = - \frac{t}{τ} + a \qquad Equation ( 3 )$$

The gamma signal is seen to respond to the heater pulses. The response involves a prompt component, which can be seen best at the end of the last triangular heater pulse where the signal decreases suddenly following the sudden decrease in the heater temperature. There is also a much slower component which is perhaps most obvious following the second to last heater pulse which ends around 1.55×10⁶ sec. Following this heater pulse the signal decreases slowly, and then undergoes subsequent dynamics that seem to be part of a slow transient perhaps produced by the pulse.

3.4. Time History for the Fe K-alpha X-Ray

In the May 20 implementation the largest non-exponential decay effect was seen in the case of the Fe K-alpha x-ray, where the fractional increment was a bit larger than for the Fe-57 14.4 keV gamma. This provides us with motivation to consider the time history of the Fe K-alpha now for the Aug. 10 implementation.

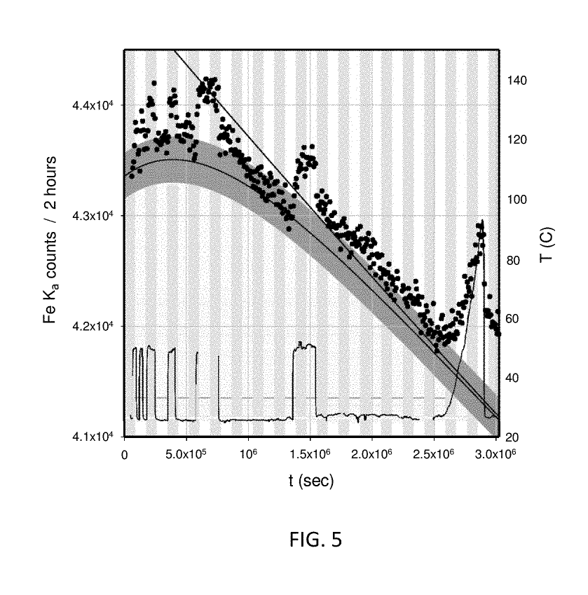

FIG. 5 plots a time history of the Fe Kα transition (circles); exponential decay with 271.74 day half-life (dark line); empirical model (curve); ±1σ error bars determined by the square root of the counts for the empirical model (shaded region that follows the curve); and counts per 2 hour accumulation time indicated on the left axis. The temperature is shown in the bottom part of the plot (lower plot); with the temperature axis indicated on the right axis. The bottom time axis is in seconds; the alternating yellow and white background show the duration of each day between in the plotted time interval.

In FIG. 5, a significantly stronger version of the anomaly is seen than was present in the Fe-57 14.4 keV gamma signal above. There is an obvious slow reduction in the signal. We made use of a subset of the data points to fit to an empirical model of the form of Equation (1) with non-exponential fitting parameters

b=−0.0378 τ_{b}=7.72×10⁵ sec Equation (4)

The time history of the Fe K-alpha x-ray shows a strong response to the heater pulses, stronger than for any of the other signals considered in this paper. As before there is a prompt component that results in an increase correlated with the temperature increase, and a second component that decays following the heater pulse, and which shows additional dynamics (for example after the 6th heater pulse).

3.5. Increase of Incremental Signal with Temperature

The slow triangular heater pulse near the end of the run was intended to shed light on the temperature-dependence of the incremental signals for the Fe-57 14.4 keV gamma and Fe K-alpha x-ray. The hope in this case was that we might see a nonlinear dependence which would support an interpretation connected with the dislocation velocity increasing with temperature.

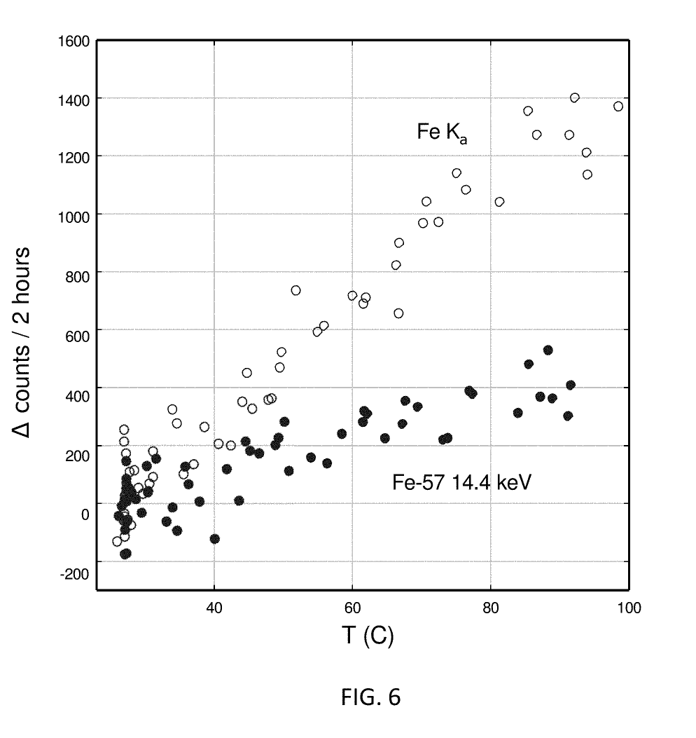

FIG. 6 shows the incremental counts in both cases as a function of temperature. One sees that in both cases the incremental signal increases roughly linearly with temperature. This roughly linear dependence suggests that the increment is dominated by incremental stress effects, perhaps due to the expansion of the wood clamps.

4. Results: Geiger Counter Data

The Geiger counter was located on the front side facing the Co-57 in this implementation off to the side with the thought of perhaps learning something about the isotropy of the anomaly. For example, one might imagine a scenario in which all of the anomalous effects seen by the Amptek in the May 20 implementation were due to collimation effects. If a detector off to the side does not see the anomaly, or else sees a weak version of it, then such a result would support the notion that the anomaly might be due primarily to (partial) collimation in the direction normal to the surface in the direction of the Amptek. Alternatively, a strong anomaly observed off-axis and also on axis would argue against a collimation effect.

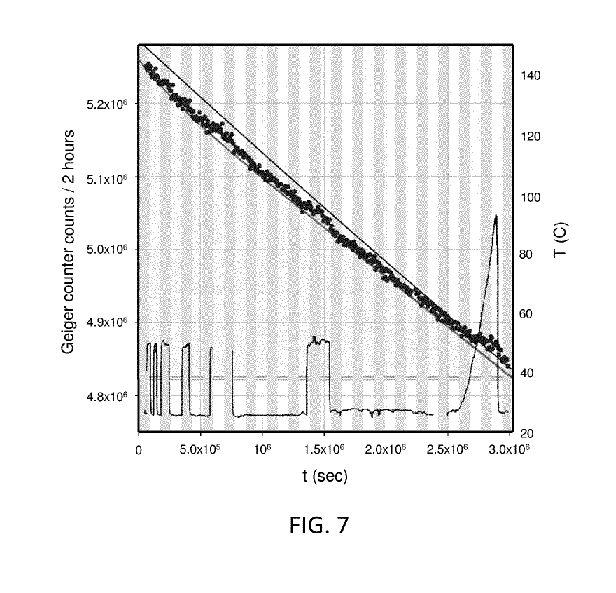

The observed time history in this implementation is shown in FIG. 7. We see overall a slow response in which the Geiger counter signal falls below what would be expected for the 271.74 day half-life associated with the beta decay of Co-57. Plotted with the data is an empirical model given by

$$ln I ( t ) = - \frac{t}{τ} + a + b {e}^{- t / {τ}_{b}} + {ce}^{- t / {τ}_{c}} \qquad Equation ( 5 )$$

where τ is 271.74/ln 2 days, and with the fitting parameters associated with the slow non-exponential decay

b=−0.0140 τ_{b}=1.69×10⁶ sec

c=0.00901 τ_{c}=4.48×10⁵ sec Equation (6)

The solid black line corresponds to the part of the empirical model without non-exponential decay terms

$$ln {I}_{0} ( t ) = - \frac{t}{τ} + a \qquad Equation ( 7 )$$

We can also see a clear but weak response to the applied heat pulses. The signal increases when the temperature is raised, consistent with the Fe Kα, the Fe-57 14.4 keV gamma, and with the strong 122 keV+136 keV gamma signal of the NaI detector (the latter is discussed in the following section). In subsequent tests it was noted that the Geiger counter response is dominated by the harder gammas.

FIG. 7 is a plot of the time history of the Geiger counter counts (dark circles); exponential decay with 271.74 day half-life (black line); empirical model (curve); ±1σ error bars determined by the square root of the counts for the empirical model (shaded band that follows the curve); and counts per 2 hour accumulation time indicated on the left axis. The temperature is shown in the bottom part of the plot (lower plot); with the temperature axis indicated on the right axis. The bottom time axis is in seconds; the alternating shaded background show the duration of each day in the plotted time interval.

Results: NaI Detector Data

We brought in the sodium iodide detector to look at the harder gammas at 122.06 keV and at 136.47 keV, which are not monitored by the Amptek. In earlier work we made use of the Sn K-alpha proxy to gain information about the dynamics of the harder gammas; in this implementation we now have direct measurements.

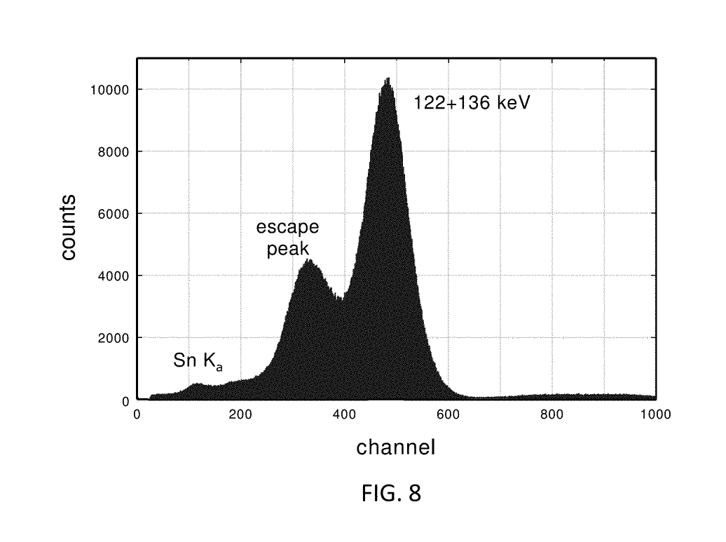

The NaI detector is very efficient, but the energy resolution is poor. FIG. 8, showing counts as a function of channel for the NaI detector for the lowest 1000 channels, shows a spectrum from the back side of the plate taken on Aug. 4, just before the Aug. 10 implementation. The poor spectral resolution does not permit a separation of the two harder gammas, so we see a peak centered at channel 481 which corresponds to the average gamma energy 123.61 keV. There is an obvious escape peak centered at channel 335 which we would expect to correspond to an energy of 94.43 keV. Finally, the Sn K-alpha appears at low energy centered at channel 111, which corresponds to an energy of 29.18 keV. This x-ray appears clearly in x-ray spectra taken on the back side in subsequent implementations. Unfortunately we have as yet not been able to establish an accurate calibration for this detector (more calibration spectra will be needed for this).

5.1. Time History for the 122 keV+136 keV Peak

We focus first on the dynamics of the strong peak due to the 122 keV and 136 keV gammas, which gives us information about the occupation of the Fe-57 136.47 keV excited state, or perhaps the degree of isotropy in the case that there is phase correlation present.

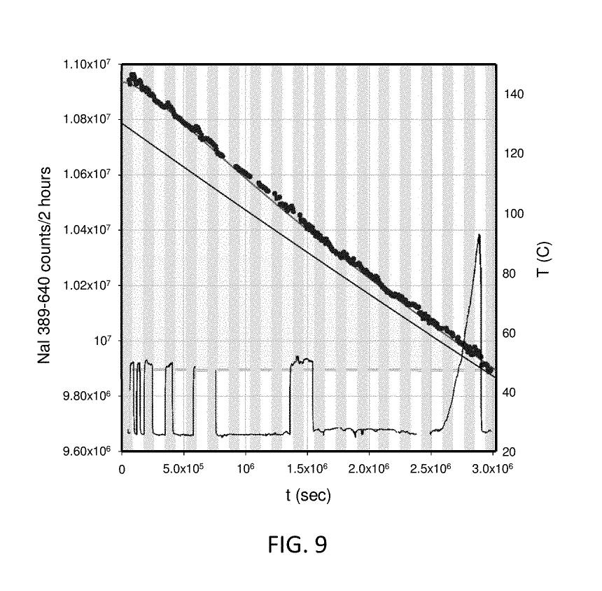

FIG. 9 is a time history plot of the NaI detector main peak channels 389-640 (blue circles); exponential decay with 271.74 day half-life (upper black line); empirical model (intermediate curve); ±1σ error bars determined by the square root of the counts for the empirical model (mostly hidden shaded region that follows the curve); and counts per 2 hour accumulation time indicated on the left axis. The temperature is shown in the bottom part of the plot (lower plot); with the temperature axis indicated on the right axis. The bottom time axis is in seconds; the alternating yellow and white background show the duration of each day of the plotted time interval.

For this we plot the number of counts per 2 hour time segment for channels 389-640 as a function of time in FIG. 9. There is an obvious non-exponential decay of nearly 2% where the measured gamma signal falls more rapidly than would be expected from the 271.74 day half-life for the beta decay of Co-57.

In this case we have compared the data with an empirical model given by

$$ln I ( t ) = - \frac{t}{τ} + a + b {e}^{- t / {τ}_{b}} + {ce}^{- t / {τ}_{c}} \qquad Equation ( 8 )$$

with τ the relaxation time associated with the Co-57 half-life (τ=271.74/ln 2 days), and with fitting parameters

b=0.0212 τ_{b}=1.69×10⁶ sec

c=0.00747 τ_{c}=2.00×10⁵ sec Equation (9)

In this time-history as well as in others from the NaI detector the non-exponential decay appears to involve two distinct decay effects with separate relaxation times. In this case we can optimize the fit to determine the longer relaxation time accurately; however, for the shorter relaxation time we chose a representative value that seemed close to the data (since optimization in the presence of the shorter heat pulses at early time is problematic). Consistent with this empirical model is the expected exponential intensity if no anomaly were present (plotted as a black line below the data in FIG. 9):

$$ln {I}_{0} ( t ) = - \frac{t}{τ} + a \qquad Equation ( 10 )$$

We see in the data reasonably prompt responses to the short heat pulses at early times, and also the longer flat pulses later on. Note that after the heat pulse near 1.37×10⁶ we observed a number of transients in the Fe K-alpha time history, which appears to be reflected in some weak transients that can be seen in the harder gamma history. We do not see the same strong response roughly linear in temperature for the final triangular heat pulse in this case.

5.2. Time History for the Escape Peak

An escape peak is present because of loss of the iodine K-alpha from the NaI crystal, so that the associated energy is not deposited in region of the detector where it can be measured. We might naively expect that the escape peak would exhibit a dynamics similar to that seen in the main peak, which is what we would see under more normal conditions.

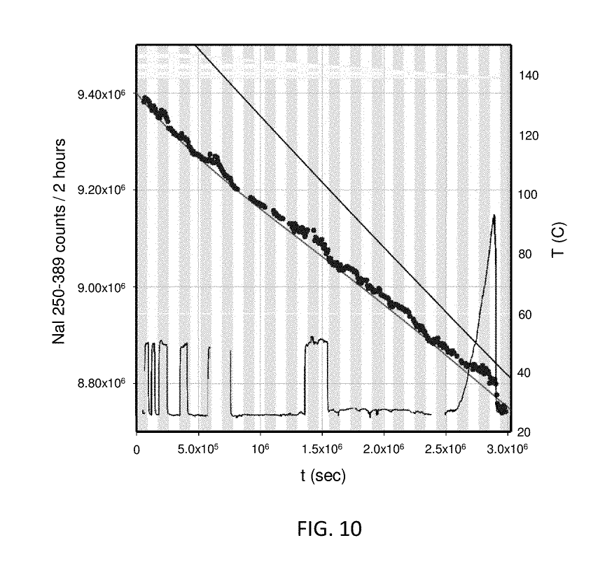

FIG. 10 is a time history plot of the NaI detector escape peak channels 250-389 (blue circles); exponential decay with 271.74 day half-life (black line); empirical model (intermediate curve); ±1σ error bars determined by the square root of the counts for the empirical model (not visible at illustrated scale) and counts per 2 hour accumulation time indicated on the left axis. The temperature is shown in the bottom part of the plot (lower plot); with the temperature axis indicated on the right axis. The bottom time axis is in seconds; the alternating yellow and white background show the duration of each day in the plotted time interval.

The time history for the escape peak is shown in FIG. 10. Note that due to the relative position of the detector relative to the plate, the magnitude of the escape peak in terms of counts summed over channels is similar to that for the main peak in this implementation. We see a substantial non-exponential decay effect where the decay is slower than what would be expected from the 271.74 day half-life associated with the Co-57 beta decay. The empirical model fitting parameters associated with the non-exponential decay are

b=−0.0619 τ_{b}=1.51×10⁶ sec

c=0.0375 τ_{c}=8.30×10⁵ sec Equation (11)

Clearly the non-exponential decay associated with the escape peak is more pronounced than for the main peak.

We also see a larger response to the heat pulses generally in this time history than was seen in the time history of the main 122 keV+136 keV peak. There is now an obvious strong response to the triangular heat pulse near the end of the implementation.

5.3. Time History for a Set of Low-Energy Channels

Our attention is focused next on the time history of the low-energy channels in the vicinity of the Sn K-alpha. We might expect the Sn K-alpha (and the weaker Sb K-alpha) produced by photoionization in the steel plate to contribute in proportion to the harder 122 keV+136 keV gamma signal, but we do not expect other x-ray emission. Note that the majority of the counts in this region most likely do not come from x-rays from the back of the plate; the Sn K-alpha provides only a minor component, while Compton scattering from harder gammas contributes the majority of counts. Nevertheless, we are motivated to examine this time history mostly to see what is there.

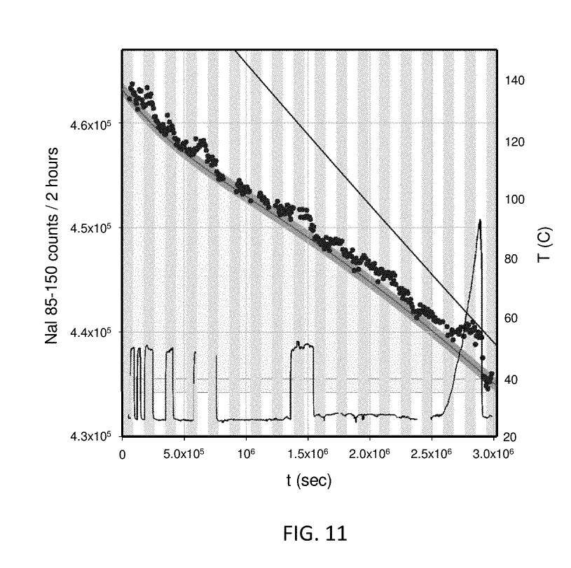

FIG. 11 is a time history plot of the NaI detector low energy channels 85-160 (black circles); exponential decay with 271.74 day half-life (black line); empirical model (curve); ±1σ error bars determined by the square root of the counts for the empirical model (shaded region that follows the curve); and counts per 2 hour accumulation time indicated on the left axis. The temperature is shown in the bottom part of the plot (lower plot); with the temperature axis indicated on the right axis. The bottom time axis is in seconds; the alternating yellow and white background show the duration of each day of the plotted time interval.

Results for the time history for channels 85-160 are shown in FIG. 11. The empirical model parameters associated with the non-exponential decay in this case are given in Equation (12). These are similar to those for the escape peak as we had expected.

c=0.0321 τ_{c}=6.50×10⁵ sec Equation (12)

However, the response of the signal to the heat pulses is much more pronounced that for the time history of the channels associated with the escape peak.

5.4. Time History for Higher Energy Channels Above the Main Peak

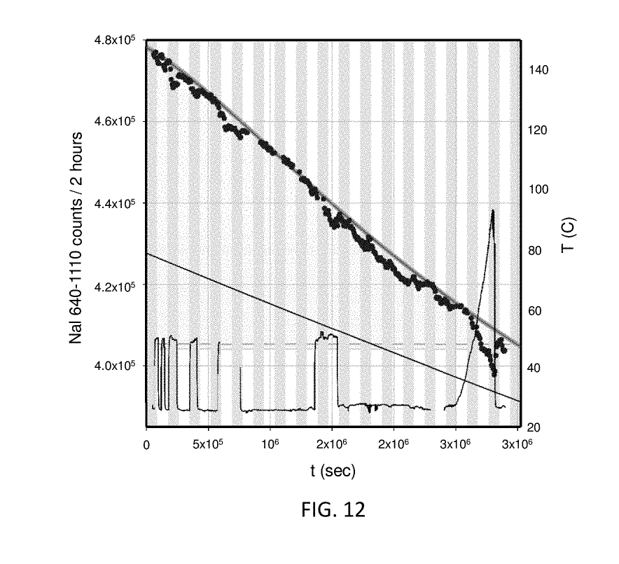

Above the main peak we see counts in the NaI spectrum, which motivates us to think about why they should be there. Certainly there are some even harder gammas from Co-57 decay in to more highly excited states at 366.76 keV and 706.42 keV, with very weak gammas lines expected at 230.29 keV, 339.54 keV, 352.36 keV, 366.75 keV, and so forth. However, the strongest of these lines are expected to be weaker by a factor of about 26,000 than the main peak that we see, so we do not attribute the counts observed to such lines. Much more likely is the possibility that we are seeing a broad summation peak due to two or more of the harder 122.06 keV and 136.47 keV gammas. Consequently, we might naively expect to see an associated time history something like the time history of the main 122 keV+136 keV peak. To investigate, we show the time history associated with the higher energy channels 640-1110 in FIG. 12.

FIG. 12 is a time plot of the NaI detector high energy channels 640-1110 (black circles); exponential decay with 271.74 day half-life (black line); empirical model (upper curve); ±1σ error bars determined by the square root of the counts for the empirical model (shaded region that follows the curve); and counts per 2 hour accumulation time indicated on the left axis. The temperature is shown in the bottom part of the plot (lower plot); with the temperature axis indicated on the right axis. The bottom time axis is in seconds; the alternating yellow and white background show the duration of each day in the plotted time interval.

We see that there is a substantial non-exponential decay associated with an excess of counts at early time. The associated empirical model fitting

b=0.368 τ_{b}=1.51×10⁶ sec

c=−0.256 τ_{c}=1.09×10⁶ sec Equation (13)

In this case the two time constants are more comparable resulting in more cancellation than for the earlier time histories.

We see the signal is impacted by the heat pulses, but this time the response is a reduction in counts in response to the temperature increase, in contrast to the earlier time histories where the counts increased. The response to the final triangular heat pulse is more linear than for the earlier data sets.

Discussion and Conclusions

The Aug. 10 implementation was clearly important, one which showed anomalies in all of the detectors, control, and provided much new information.

6.1. Response to Heater Pulses and Control

Perhaps the most significant new result demonstrated in this implementation is the ability to control the anomaly in the sense that we can see a prompt incremental increase in the Fe K-alpha x-ray and Fe-57 14.4 keV gamma in response to a temperature increase. In the May 20 implementation we saw non-exponential decay of these lines that began from the start of the implementation, but we were not able to see the signal increase from a nominal state to a state of increased emission. In the Aug. 10 implementation we see several examples of a response directly to the temperature pulse. We are able to apply a stimulation in the form of the heater pulse and control (to some degree) the enhancement, both in turning on the anomaly as can be seen in the first six square pulses, and also in the turning off of the anomaly as can be seen at the end of the last long triangular heater pulse.

6.2. Heater Pulse Functionality

As mentioned in the text a motivation for implementing heater pulses in the first place was to see whether we might increase the dislocation velocity and by doing so increase THz phonon generation. If this occurred the response would be maximized when the temperature was highest, and go away at the end of a heater pulse. We see a response that continues after the heater pulse, which cannot be due to an increased dislocation velocity, but is perhaps consistent with the interpretation of increased stress produced by the wood blocks upon heating that leads to subsequent dynamical relaxation and creep.

The two functionalities identified can be separated. For example, it would be possible to apply a heater pulse localized to the wood clamps to increase stress while using a blower to keep the steel plate temperature down. In this way we could isolate the stress enhancement from any increase in dislocation velocity that might occur. Alternatively, we could apply stress with a hydraulic press at room temperature, which would impose this part of the functionality with little temperature increase.

To raise the steel temperature while minimizing the change in applied stress could be accomplished by replacing the wood clamps with metal clamps, using a metal with low thermal expansion. It would be possible to monitor the applied stress directly with a gauge, and if needed use feedback to eliminate changes in the stress due to heater pulses.

At present we cannot adopt a unique interpretation for the prompt response of the anomaly to the thermal stimulation, as it might be due in part to the prompt increase in stress, or it might be due to a modification of the dislocation velocity.

Further tests which isolate the temperature effect from the stress effect are needed for clarification.

6.3. Anomalies in the NaI Channels

In the May 20 implementation we saw exponential decay of the Sn K-alpha under conditions where the statistical noise limited our ability to see small non-exponential decay effects. The Geiger counter on the back side in that implementation showed a significant anomaly, the origin of which was not clear since the Geiger counter responds most strongly to the harder 122 keV and 136 keV gammas. We do not know from the data taken whether the Geiger counter anomaly is due to an anomaly in the harder gammas, or whether there were contributions due to up-conversion that would involve lower energy lines.

However, in the Aug. 10 implementation the NaI detector provides for a direct detection of the harder gammas, and does so with high efficiency so that the statistical noise is a small fraction of the total counts. Normally one would like a NaI detector oriented so that the large area of the NaI crystal faces the sample being tested; however, in the Aug. 10 implementation the orientation is such that the side of the NaI crystal faced the Co-57, which maximizes the fraction of the signal in the escape peak. Having the detector oriented sideways in the Aug. 10 implementation resulted in the escape peak having roughly the same number of counts as the primary peak, which is bad because spectra with a large primary peak and weak escape peak is what the detector is supposed to produce. However, in this case the unconventional orientation had the unforeseen advantage of providing information about the anisotropy of the signal that would otherwise not have been obtained.

For the primary peak (channels 389-640) we see that the NaI signal has a positive non-exponential decay component, so that the overall signal is above the exponential decay line by about 2%. The escape peak has a non-exponential component that lies below the escape peak by a bit less than 4%. Hence, overall the sum would show a reduction at early time by on the order of 1.5%. The Geiger counter on the front side shows a slow reduction on the order of 1.4%, which seems consistent. However, both are inconsistent with the Sn K-alpha proxy which shows a much smaller deviation from exponential decay.

6.4. Possible Anisotropy and the NaI Time Histories

We draw attention to the evidence for collimation and beamlet formation of gammas thought to be near 90 keV in the Gozzi experiment, suggesting the presence of phase coherence among the emitting nuclei. Collimation is also claimed in the Karabut experiment, and in the experiments of Kornilova, Vysotskii and coworkers, for lower energy x-rays.

Regarding collimation, this line of thought might provide a possible resolution to the contradiction between the Sn K-alpha and NaI measurements. Suppose that the angle-averaged emission of the harder 122 keV and 136 keV gammas decays exponentially, which would be consistent with the Sn K-alpha observation, since the Sn K-alpha results from photoionization in Sn atoms that extend over 2π steradians. Now suppose in addition that there was phase coherence among the Fe-57 nuclei on one or both of the 122 keV and 136 keV lines, resulting in an anisotropy in the emission. In this case we could account for deviations from exponential decay in the primary and escape peaks as due to subtle changes in the local intensity in the vicinity of the NaI crystal edge.

6.5. More General Implications of Anisotropy

If we for now accept that a substantial time-dependent anisotropy is present in the Aug. 10 implementation, then we might ask what impact anisotropy would have on the earlier May 20 implementation where it would reasonably have been expected to occur. The first place to look would of course be in the Geiger counter data for the May 20 implementation, where we see a nearly 10% enhancement at early time. We know that the harder gammas dominate the Geiger counter response, so it would seem quite plausible that the Geiger counter anomaly could be due to an increase in the emission at shallow angle to the plate surface.

We also saw a significant enhancement at early time in the Fe-57 14.4 keV gamma emission on the front side in the May 20 implementation. If anisotropy can be an issue for the harder 122 keV and 136 keV gammas, it seems probable that an even bigger anisotropy should be expected for the lower energy and longer lived 14.4 keV gamma. In other implementation we expect and diagnose for anisotropic emission in the 14.4 keV line.

The situation is qualitatively different in the case of the Fe K-alpha x-ray. We saw the largest enhancement at early time in this line in the May 20 implementation, and we see the biggest reduction at early time in this line in the Aug. 20 implementation. However, we would not expect it to be possible for there to be phase coherence on this transition, if for no other reason than the electron ejected by internal conversion should be emitted in a random direction. Nevertheless, probably this transition should be included in any test for anisotropy, either to be certain from direct measurement that there is no associated anisotropy, or as a control if there is certainty.

We draw attention to the Sn K-alpha, which appears to be very nearly exponential in both implementations, and which should be due to the angular integration over 2π steradians. This suggests that in some implementations, a foil converter is used to make use of other K-alpha emission that targets specific emission lines. For example, we could get angle-averaged information about the Fe K-alpha at 6.4 keV using a Cr foil with a K-edge at 6.0 keV, and then monitoring the time history of the resulting Cr K-alpha emission. In the case of the Fe-57 14.4 keV gamma, the Kr edge is closest, but probably we would want to make use of Br (with a K-edge at 13.5 keV) or Se (with a K-edge at 12.7 keV). For example, if we think that up-conversion is responsible for the enhancement on either transition, and angular-integrated diagnostic would be critical to help make the case, or else to prove otherwise.

6.6. Possibility of Control of the Anisotropy

In previous work we have considered the possibility of collimated emission normal to the surface as a result of phase coherence among emitters combined with local order in the crystalline structure, as a way to understand collimated emission in the Karabut experiment. In our implementations we use rolled steel, which we would expect to have a significant number of crystal planes aligned with the surface as a result of the rolling. Resonant excitation transfer could result in phase coherence and collimation normal to the surface. However, it should be possible to have non-resonant excitation transfer effects, which could result in non-uniform nuclear phases. It may be possible to steer the anisotropy making use of directional THz phonons near the Co-57. For example, pressure may be applied first to a pinch point on one side of the Co-57; and this may direct the gammas on average away from the pinch point due to phonon momentum exchange mixing with the gamma emission. Pressure applied to a pinch point on the other side of the Co-57 may then drive the gammas away from the pinch point in the other direction.

6.7. Reduction at Early Time

In the May 20 implementation we saw an enhancement at early time in the Fe-57 14.4 keV transition, and also in the Fe K-alpha transition; however, in the Aug. 10 implementation we saw instead a reduction. In both cases we attribute the non-exponential decay to stress induced when the clamps were tightened just prior to the implementation. And in both cases the magnitude of the anomaly is relatively large. An obvious question is why an enhancement in the May 20 implementation, and why a reduction in the Aug. 10 implementation.

In our previous discussion of the May 20 implementation we viewed up-conversion as a candidate mechanism to account for the enhancement. Correspondingly we view down-conversion as a candidate mechanism to account for the reduction. Theoretically, up-conversion and down-conversion are very closely related mechanisms, so if one can occur we should expect that the other could occur. After thinking some about models relevant to why the system would up-convert instead of down-convert has to do with the amount of THz phonons: a higher occupation of THz phonons favors up-conversion; and a lower occupation favors down-conversion. Within this framework then, the heater pulses results in an increase in the number of THz phonons that interact to enhance up-conversion, presumably due to increased stress.

To help clarify the question is whether we might develop techniques that utilize this issue. For example, if we induced stress at a pinch point close to the Co-57, we may see an up-conversion effect. Then if we induce stress at a pinch point much further away we may produce a down-conversion effect. If instead of a heater pulse we introduced a cooler pulse, we may see a transient reduction in emission.

Note that the significantly larger incremental enhancement seen during the heater pulses for the Fe K-alpha x-ray than for the Fe-57 14.4 keV gamma observed in this implementation supports the notion of up-conversion as a mechanism. Since it takes less up-conversion to produce the Fe K-alpha at 6.4 keV than the 14.4 keV gamma, we might expect it to be possible to produce conditions where the lower energy line is favored over the higher energy line.

6.8. Systematic Approach

At least partial control over the anomaly using heater pulses is demonstrated in this implementation. This, combined with a degree of reproducibility that we observe associated with similar heater pulses, allows for the possibility of a more systematic approach. For example, suppose that we carry out two implementations where we apply identical heater pulses, in one case with a steel plate that has gel on the back, and one where there is no gel on the back. With such a test we should be able to clarify whether the gel makes a difference, and if so, how much of a difference. Such an implementation has by now been carried out (as will be reported elsewhere) with the result that the presence of gel on the back side produced a larger anomaly in the time history of the Fe-57 14.4 keV gamma and in the Fe K-alpha x-ray.

We view the possibility of much more systematic approach that makes use of this kind of approach as being the most significant contribution of the Aug. 10 implementation.

Addendum 1—Observation of Non-Exponential Decay in X-Ray and γ Emission Lines From Co-57—Support is provided for proposed conversion mechanism between lattice vibrations and nuclear excited states through phonon-nuclear coupling. Prior art reported excess heat in electrolysis experiments with Pd cathodes and D electrolyte (FP heat effect). The large amount of observed excess heat relative to the materials present precluded all explanations but that of nuclear energy of some kind being released. The experiments and associated conjectures were soon rejected by the wider scientific community, primarily for two reasons. The absence of commensurate radiation could not be explained in any existing theoretical picture (the proposed D+D to He-4 reaction is expected to produce 24 MeV Gamma emission which was never observed); consequently, most experiments that suggested D+D fusion in the absence of Gamma radiation got dismissed from the outset. In most FP heat effect experiments, heat was claimed to be the primary output of the reaction. Heat is difficult to measure accurately, many physicists lack experience with calorimetry (heat measurement) and consider it an insufficient basis for claiming nuclear reactions (possibly rightly so).

Peter Hagelstein explored potential theoretical mechanisms that could explain the absence of radiation alongside nuclear reactions and that are consistent with established principles of physics. After many modelling attempts, he concluded that the only feasible mechanism would be a conversion of the large energy quantum resulting from a nuclear reaction mass defect into a large number of small vibrational quanta in the form of phonons. Phonons are vibrations of the atomic lattice of condensed matter materials such as metals. In other words, the surrounding metal lattice would absorb the resulting nuclear energy quantum—not entirely different from the Mössbauer effect.

Hagelstein has identified such a phonon-nuclear coupling as being derivable from the Dirac equation for multi-particle nuclei. The coupling was not before recognized as physically relevant and remained neglected by theorists through following decades.

Hagelstein's model also addresses under what circumstances phonon-nuclear coupling can come into effect and become macroscopically observable (in short: in the presence of highly excited phonon modes, a phonon loss mechanism in the form of damping, and an arrangement of nuclides with compatible energy levels in the bulk material). The model further suggests that the coupling and the related conversion mechanisms operate in both ways: nuclear quanta can be down-converted to vibrational quanta (as is allegedly the case in FP type experiments); and vibrational quanta can be up-converted to nuclear quanta. The latter suggests that high-frequency lattice vibrations can lead to excited state nuclei and the emission of commensurate radiation (when shortly after they fall back to ground state).

Experimental results that demonstrate phonon-nuclear coupling via an up-conversion effect would be easier to produce and more unambiguously interpretable compared to FP heat effect experiments. This is in part because radiation outcomes can be measured much more precisely and unambiguously compared to heat outcomes.

Hagelstein learned about observations of collimated X-rays in environments with vibrating metals from several groups in Italy and Russia. None of these groups were able to provide coherent theoretical explanations for their observations. The reported anomalies, in combination with the commensurate predictions of Hagelstein's models, motivated our approach—with the goal to observe radioactive emission induced by mechanical vibrations.

In the course of refining the theoretical model, it was noticed that there are yet simpler versions of experiments with fewer unknown parameters. Instead of up-converting vibrations into nuclear excitation, we could attempt to demonstrate the transfer of excitation from excited nuclei to ground state nuclei of the same kind. Effectively, this would lead to a delocalization of a radioactive source on a sample i.e. a spreading out of radiation towards other, stable atoms and a reduction of emission at the radiation source itself. The above described implementation yielded first observations of predicted anomalies, as described below.

Excitation transfer implementation—Hagelstein showed that a coupling between phonons and nuclear excited states is theoretically possible and consistent with established physics. The existence of such a coupling suggests several feasible energy conversion mechanisms between lattice vibrations and nuclear potential energy: excitation transfer, up-conversion, down-conversion, and subdivision—all mediated through energy exchange with phonons. Transferring excitation from excited nuclei to ground state nuclei depends on the fewest number of parameters; which gives it the greatest chances to get relevant parameters right and yield observable effects of phonon-nuclear coupling. Demonstrating the existence of Hagelstein's phonon-nuclear-coupling not just theoretically but also experimentally in an experiment that can be well understood and even quantitatively modeled opens the door to systematic study of the FP heat effect and related anomalies.

Co-57 in acid was evaporated onto the surface of a 3×6″ steel plate as represented in FIG. 1. The radioactive source occupies an area of about 50 mm2. We sealed the source with a layer of transparent epoxy for safety purposes. 200 uCi of Co-57 was delivered to the steel plate.

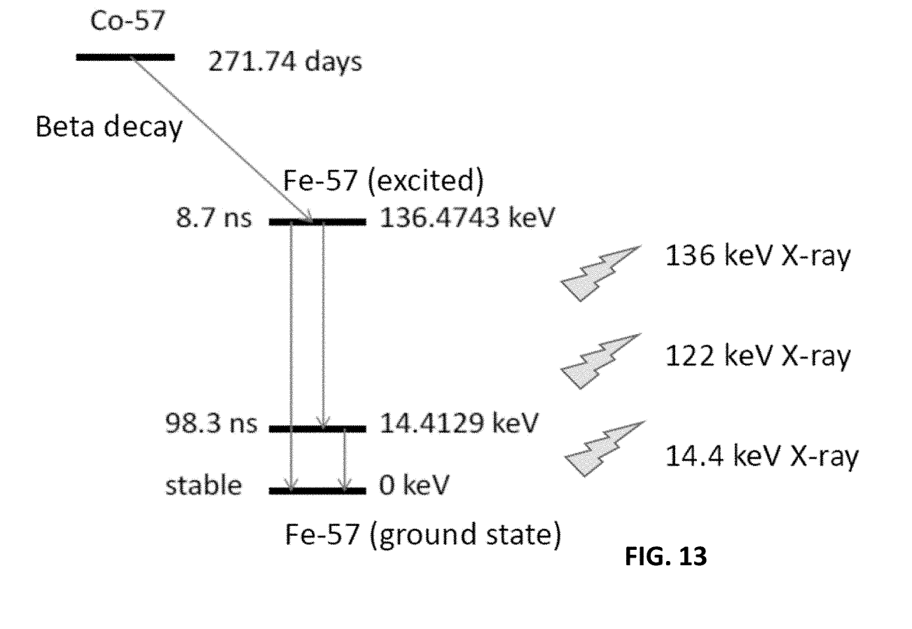

FIG. 13 shows the Co-57 decay scheme. Every unstable nucleus decays according to a particular decay scheme. The decay scheme leads to a characteristic spectrum of emitted X-ray/Gamma rays with peaks at the corresponding photon energies.

X-rays and Gamma rays are electromagnetic radiation. Essentially, they are like radio waves and light, just with higher frequencies/shorter wave lengths. Electromagnetic radiation is sometimes treated as waves and sometimes as particles (photons), depending on the circumstances. Wave-length ranges have corresponding energy ranges. Lowest energy X-rays consist of photons with energies between about 100 ev and 100,000 eV.

The Co-57 sample used exhibits the following characteristic emission spectrum across the 1-150 KeV range. The 14.4 keV, the 122 keV, and the 136 keV lines are caused by photon emission directly from the nucleus (as individual nuclei fall to lower excited states and ground states). The other peaks are caused by photon emission from electronic shells of atoms in surrounding materials. This so called X-ray fluorescence (XRF) is a secondary effect of the Co-57 nuclear emission (XRF). The XRF lines are characteristic of the surrounding materials such as the alloying elements in the steel plate.

The X-ray spectrometer (X123) used is optimized for the lower part of that spectrum (1-30 KeV). We get a high resolution view of the 14.4 keV Co-57 nuclear line and the commensurate Fe K-alpha and K-beta XRF lines (present because of the large number of Fe atoms in the steel plate).

The half-life of Co-57 is about 272 days (9 months). It decays exponentially but on a daily basis, the decay curve looks almost linear, and is referred to herein as slow exponential decay.'

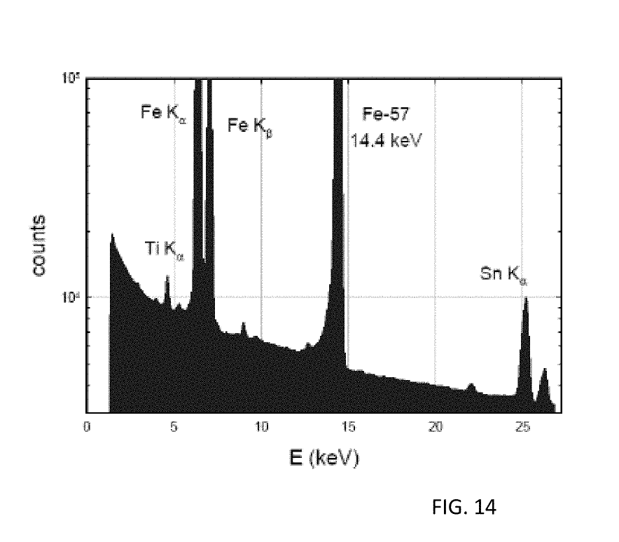

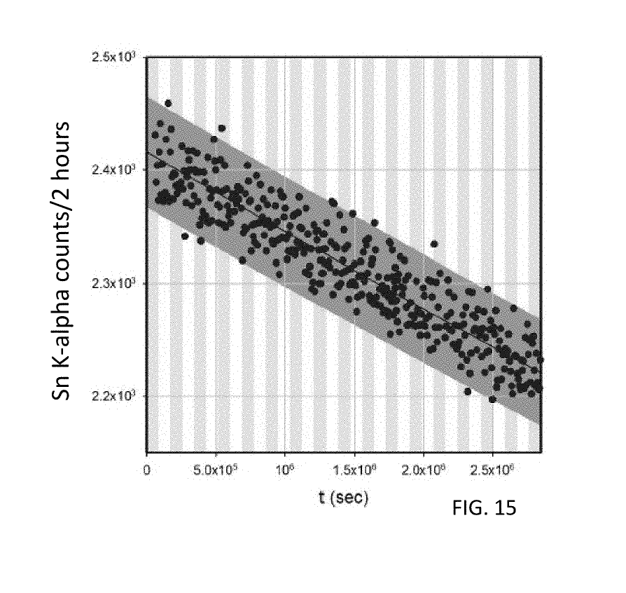

Half-life decay from the sample, absent of treatment, was observed. Expected behavior of Co-57 source over time in the collected data; slow exponential decay consistent with half-life (FIG. 15). Here, we see the expected decay time constant of the Co-57 via the tin k-alpha XRF line. This line is commensurate to the higher Co-57 nuclear line at 122 keV (FIG. 14-15).

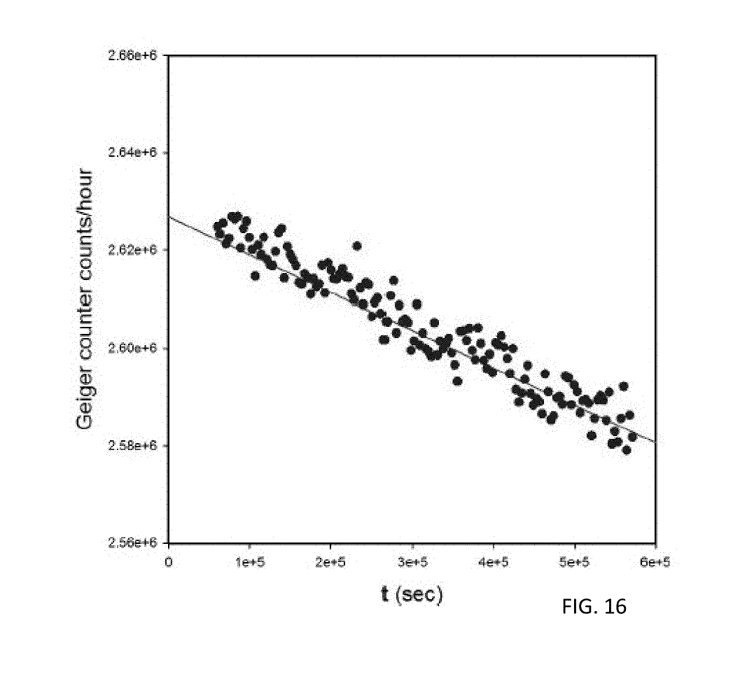

Geiger counter readings can be interpreted in first approximation as counts across the spectrum of the Co-57. So the Geiger counter readings (FIG. 16) are expected to also decline with the half-life of the Co-57—which they do.

Per the experimental data, the Co-57 source does exactly what it's supposed to be doing: it decays (exponentially, but slowly) according to its half-life, as seen above on two independent detectors. To test Hagelstein's theory of phonon-nuclear coupling we now want to create a large number of phonons in the vicinity of the source. We'd then expect the presence of phonons to act as a carrier for several possible types of conversion mechanisms: to transfer excitation from the excited state Fe-57 nuclei at the radioactive source (beta-decayed Co-57 nuclei) to other parts of the sample (ground state Fe-57 nuclei); or to trigger up-conversion of some of the phonons to excite some of the Fe-57 ground state nuclei; or to trigger down-conversion of some of the Fe-57 excited state nuclei to more phonons. Either of these conversion mechanisms would lead to a change in the X-ray emission spectrum at the location of the source and detector which we should be able to observe. Which of the conversion mechanisms applies or dominates depends on the number of phonons and the geometry of the sample. In either case: we'd expect to see a change in the emission spectrum of the radioactive source.

To address: how phonons can be created; and what phonons again—Phonons are vibrations of atoms in a crystallographic lattice such as in metals. In analogy to quanta of light (photons), these quanta of vibrations can under some circumstances be described as waves and under other circumstances as particles (or quasiparticles). Metals consist of atoms arranged in crystal lattices. Most metal lattices are full of defects called dislocations. Their movements are responsible for metal properties such as plasticity. Dislocations, their movements, and their effects are an established subfield of materials science. It is also uncontested that dislocation movement creates phonons, essentially by “rattling” the metal lattice. However, this aspect is more of a niche field of materials science and still emergent. For this work (and related applications), it is highly relevant.

When dislocations move through metal lattices, they “rattle” the lattice and create Terahertz phonons. THz phonons are noted here because they are high-energy and especially well suited for coupling to atomic nuclei. Dislocation movement, and associated phonon generation, can be caused via a range of different methods, for instance through the application of mechanical stresses or through the diffusion of hydrogen atoms through gaps in a metal lattice. Transmission electron microscopy can be used to image metal lattice patterns and stress-induced dislocations and movements.

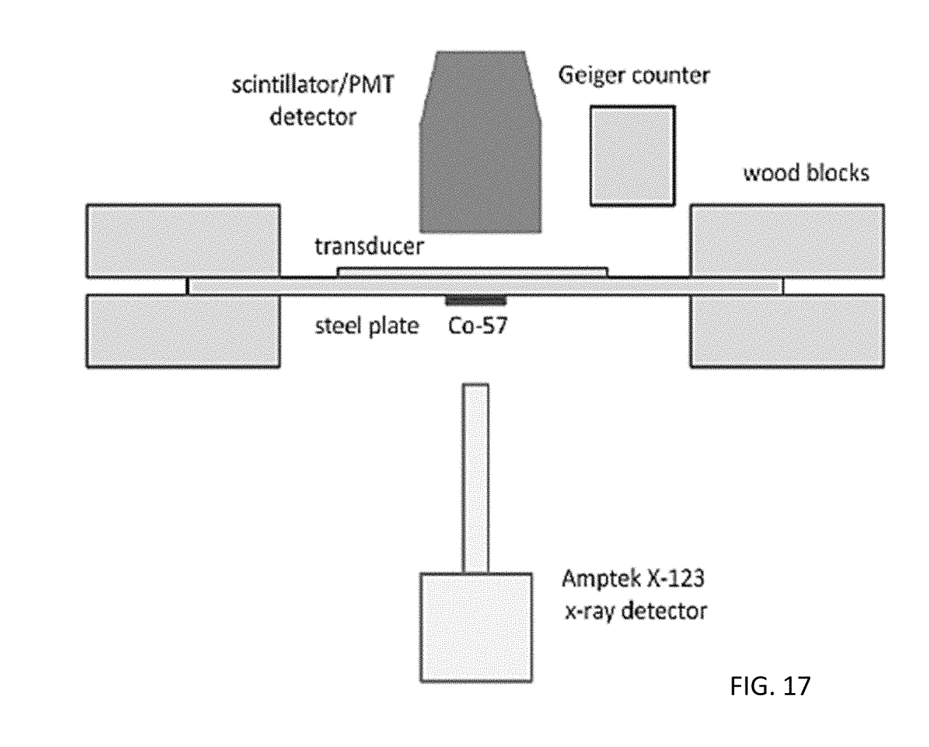

An implementation, according to at least one embodiment, is shown in FIG. 17. Wood clamps create 2000 pounds of compressional stress on the edges of the steel plate with the Co-57 source. This leads to shear stress emanating towards the plate center and corresponding dislocation movement. The moving dislocations rattle the lattice and create high-frequency phonons. If Hagelstein's models and predictions are correct, then the phonons can interfere with the emission spectrum through described energy conversion mechanisms between vibrational energy and nuclear energy (between phonons and nuclear excited states).

A Geiger counter faces the top side of the steel plate. A PMT scintillation detector faces the top side of the steel plate. An X123 detector faces the Co-57 source on the bottom side of the steel plate through a protective Al mesh. 2000 pounds of compressional stress creates pinch points; shear stress emanates towards center of the plate and the Co-57 source. The plate contains a very large number of dislocations. An upper limit for steel dislocation density is estimated around 10¹⁶ per mm². A very large number of moving dislocations create phonons throughout the plate.

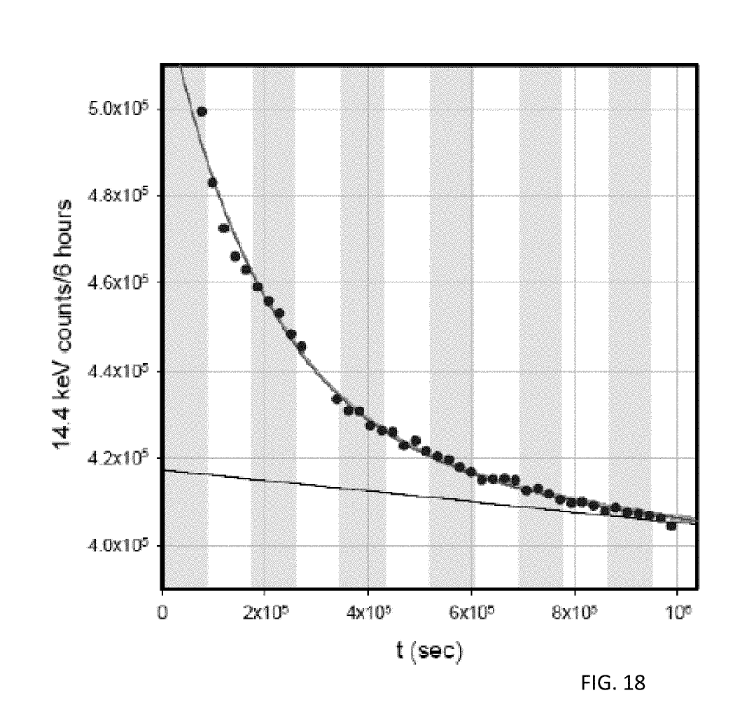

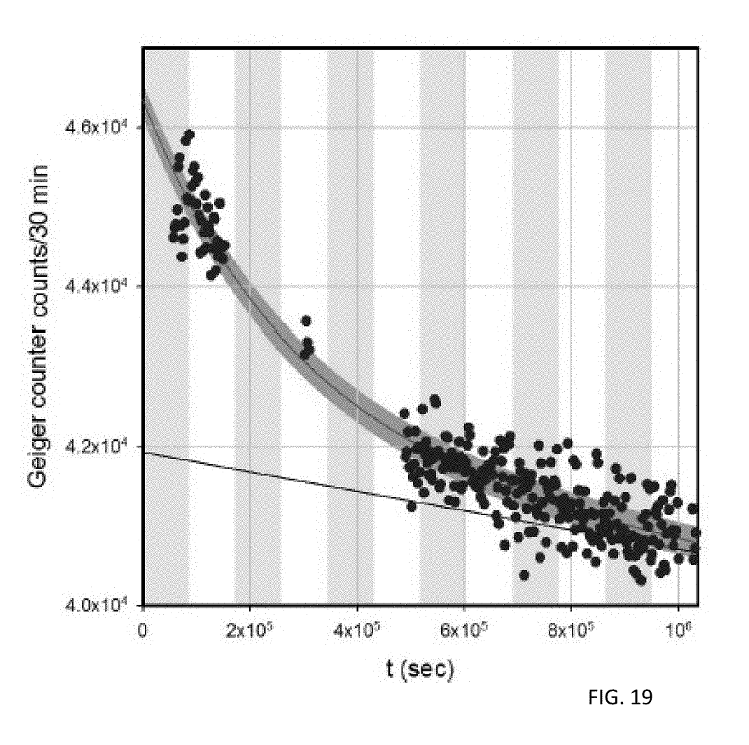

Observation of anomalous enhancement of radioactive emission—Data taken immediately after applying the compressional stress clamps for the first time is shown in FIGS. 18 and 19, in which anomalous enhancement of emission is observed with a time constant much faster than the natural half-life of the source.

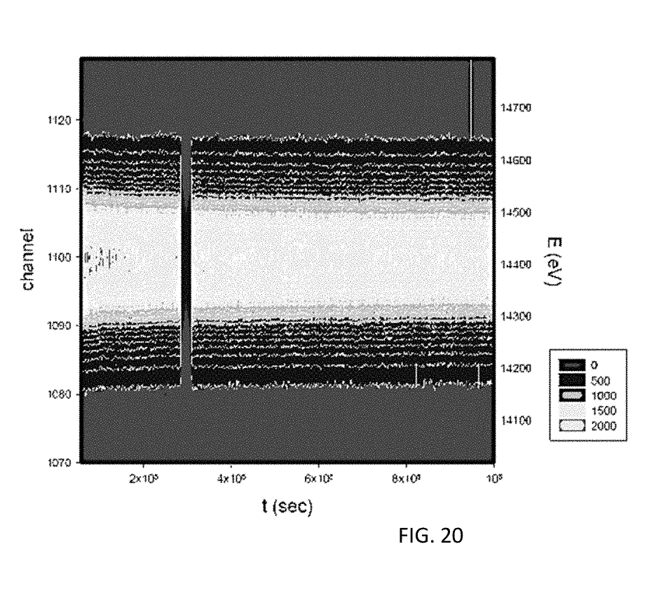

In a time-resolved view of the 14.4 keV nuclear line (FIG. 20), the source becomes brighter after the stress is applied and returns to the expected decay trajectory after about 9 days. The time scale and gradual depletion of the effect corresponds to the literature values for the time-dependence of stress induced dislocation movement (aka creep or cold flow).

Several independent detectors show a change in the exponential decay rate after applying compressional stress to the steel-cobalt sample! In the course of 9 days, the enhanced emission returns back to the original trajectory which is consistent with the Co-57 half-life. The radioactive source was temporarily made brighter by converting phonons into nuclear excitation. In this implementation, the intensity of a radioactive source has been deliberately changed. Conventional models do not address this observation, since the strong force that governs the internal states of a nucleus is believed to not be susceptible to any nonrelativistic actions from outside of the nucleus. This implementation exhibited this effect. Eight replication runs (each time with slight modifications) and one control run were carried out. The effect was observed again in all replication runs and not in the control run.

Control parameters can include increase and decrease in the temperature of the plate and the applied wood clamps via computer-controlled heating pads. Thermal expansion will then create mechanical stress on the plate on command and in situ.

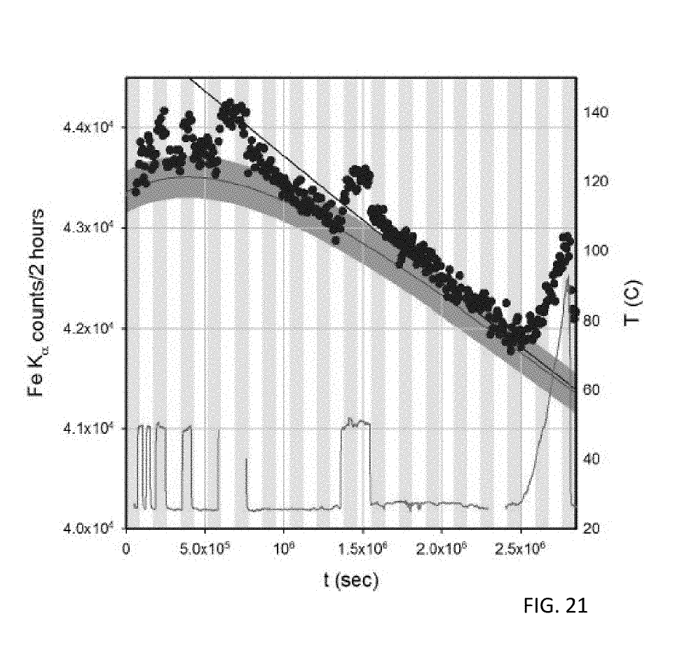

The implementation started out with a sequence of shorter heat pulses of several hours, then longer ones, then a slow temperature ramp over several days. Result: a clear correlation between the thermal-expansion-induced stress and the enhancement of nuclear emission (see FIG. 21).

A diminishment of the base signal initially i.e. after first applying the stress clamps, as opposed to the enhancement seen in the first implementation. The clamping must have generated a smaller number of creep-related phonons this time which led to down-conversion instead of up-conversion. This means that some of the excited state energies now convert into phonons instead of getting emitted as photons. This makes the radioactive source initially darker (below baseline) and the effect depletes with the time constant of creep. This kind of down-conversion effect is the same effect that we consider responsible for the absence of Gamma radiation in FP experiments. Focusing on the effect of thermal expansion and corresponding stress increase, the result: a clear correlation between temperature/thermal expansion and radioactive emission.

To address whether the detector could just be reacting falsely to the temperature, the detector has a computer-controlled thermal stabilization circuit but a temperature bias is nevertheless conceivable. However, it is proven that the detector works correctly, because the higher energy lines behave exactly the way they are expected to. A temperature bias would not be able to single out individual emission lines in accordance with our theory. Data representing different energy bands from the same run are shown in FIG. 14. The 14 keV line respond to thermal expansion whereas the 122 keV line remains unchanged. This tin XRF line (from tin in the steel plate) is proportional to the 122 keV nuclear line of the Co-57. We don't expect to have enough phonons to reach the 122 keV line and affect it and would expect this line to exhibit the classical textbook behavior, as it does (see also FIGS. 15 and 21).

This is a stronger confirmation compared to prior work as it demonstrates cause and effect in situ. Higher temperature leads to thermal expansion leads to more stress leads to more phonons leads to up-conversion (enhancement of emission intensity) instead of the initial creep-induced down-conversion (diminishment of emission intensity).

In this implementation, there is a superposition of two effects: the stress induced by the initial application of the clamps (with its longer, creep-dependent time constant) and then the thermal expansion stresses (with their shorter time constants). The different time constants match expected values in the materials science literatures on dislocation movement. In other implementations, each effect is approached in isolation.

Materials may be used that exhibit different nuclear excitation levels (e.g. Ta-181 and W-181). Pure up-conversion can be demonstrated with implementations that that involve no radioactive sources, for example up-conversion to Hg's first excited state at 1.5 keV, with applications in X-ray lithography. Different mechanisms for phonon generation can include current-induced phonon generation, through hydrogen diffusion, via THz lasers etc.

A liquid nitrogen cooled Gamma spectrometer from Ortec can allow a look at the entire X-ray spectrum of Co-57 from 1 to 150 keV at once and at high resolution. Getting a clear view of both the 14.4 keV and the 122 keV Gamma lines in the same spectrum yields valuable information regarding the ways in which the different coupling mechanisms manifest themselves.

Addendum 2—Theoretical basis for our work—Deriving phonon-nuclear coupling from accepted nuclear models; anchoring it in established literatures; deriving mechanisms and predictions for implementation.

Experimental observations suggest relationship between mechanical vibrations and X-ray emission/neutron emission. Implications include that: small vibrational quanta can be up-converted to large energy quantum and excite nuclei; and large energy quantum (e.g. from mass defect) can be down-converted into small vibrational quanta.

Hagelstein Theory: Starting with a many-particle Dirac model for the nucleus (relativistic):

$$\hat{H} = {\sum }_{j} {β}_{j} m {c}^{2} + {\sum }_{j} {α}_{j} \cdot c {\hat{p}}_{j} + {\sum }_{j < k} {\hat{V}}_{jk} ( {r}_{j} - {r}_{k} )$$

Particular Starting with a many-particle Dirac model for the nucleus (relativistic):

$$\hat{H} = {\sum }_{j} {β}_{j} m {c}^{2} + {\sum }_{j} {α}_{j} \cdot c [ \frac{\hat{P}}{N} + {\hat{π}}_{j} ] + {\sum }_{j < k} {\hat{V}}_{jk} ( {ξ}_{j} - {ξ}_{k} )$$

Applying a mathematical transform (Foldy-Wouthuysen rotation) can give us non-relativistic limits to the Dirac model of the nucleus. In this case, we want to see center of mass motion treated non-relativistically (since atoms in the lattice move only at the speed of sound or less) and relative momenta of nucleons treated relativistically (since nucleons inside the nucleus can move at much higher speeds). This gives us:

$${\hat{H}}^{′} = \frac{{\vert \hat{P} \vert}^{2}}{2 M} \frac{1}{N} {\sum }_{j} {β}_{j} + {\sum }_{j} {β}_{j} m {c}^{2} + {\sum }_{j} {α}_{j} \cdot c {\hat{π}}_{j} + {\sum }_{j < k} {\hat{V}}_{jk} + \frac{1}{M} {\sum }_{j} {β}_{j} \hat{P} \cdot {\hat{π}}_{j} + \frac{1}{2 M c} {\sum }_{j < k} [ ( {β}_{j} {α}_{j} + {β}_{k} {α}_{k} ) \cdot \hat{P} , {\hat{V}}_{jk} ] + …$$

Minor terms that are commonly ignored due to their small contributions are omitted here as well. The above equation includes, in order: a kinetic energy term for center of mass motion of entire nucleus (e.g. in a lattice); kinetic energy of each nucleon j; nuclear potential (strong force and Coulomb interaction); and coupling between center of mass motion and nuclear states. The model suggests that center of mass motion of a nucleus P (such as from oscillating atoms in a lattice) can interact with the nuclear states of the nucleus (internal nuclear degrees of freedom).

The described coupling terms were already identified by Breit in 1937 (G. Breit, Approximately relativistic equations for nuclear particles, Phy. Rev. 51 (1937) 248). Physicists at the time were mostly interested in describing scattering experiments with so-called free particles travelling in free space at constant velocity or constant acceleration. Breit noticed that under such circumstances—in the absence of changing acceleration—the coupling terms could be folded into a common kinetic Energy term.

Physicists at the time did not consider that there could be real life effects of interest where nuclei were exposed to constant acceleration changes such as when oscillating in solid state lattices. In the latter case, the folding of the coupling terms into a common kinetic Energy term is not permissible and doing it anyway veils the existence of the phonon-nuclear coupling term.

Because of its mathematical elegance and widespread acceptance at the time, Breit's mathematical treatment of the multi-particle model of the nucleus has been used as foundation for most follow-on research, largely without much scrutiny.

The above establishes the existence of a phonon-nuclear coupling implicit to the Dirac model of the nucleus. The next question is: under what conditions can such a coupling come into effect?

There is another theoretical challenge associated with this: Phonons carry only a small amount of energy (fractions of an eV) whereas the cited anomalies report keV levels of photon emission and corresponding nuclear excited states. A simple example: in the case of the alleged emission of 1.5 keV from mercury, 15,000 phonons of 0.1 eV each would be needed to collectively excite a single mercury nucleus into its first excited state. Energy exchange across such vastly different energy levels/frequencies is typically considered extremely unlikely. Hagelstein demonstrated that such energy exchange can become feasible from the perspective of the established Spin-Boson Model derived from Bloch and Siegert (1940) and popularized by Cohen-Tannoudji (1997 Nobel Prize).

Coherent energy exchange: The Spin-Boson Model describes the coupling between a two-level system (in our case the energy states of a nucleus) and an oscillator (the phonons). It includes a term for two-level systems, a term for harmonic oscillator energy, and a term for linear coupling between two-level systems and oscillator.

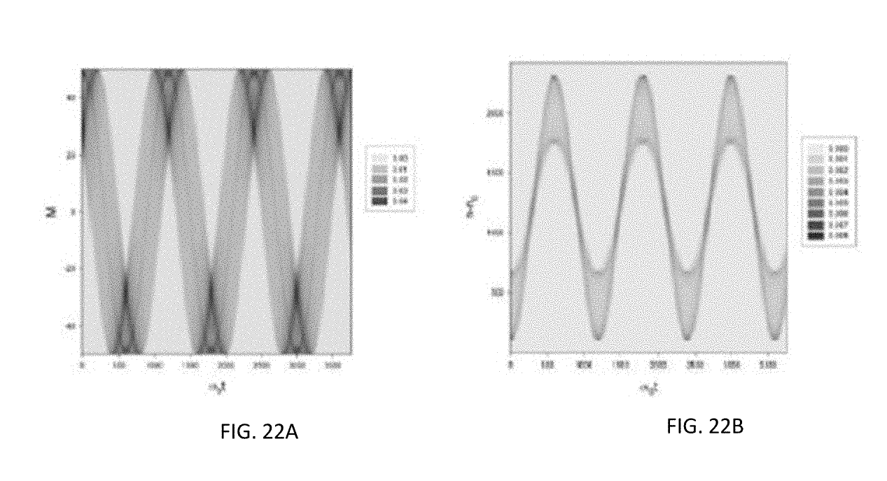

In its generic version, the Spin-Boson Model can describe a coupling between two-level systems and oscillators with vastly different energy levels. However, it predicts nonlinear Rabi oscillations where all nuclei transfer between ground state and excited state instead of individual nuclei remaining excited while the rest of the system decays. See FIGS. 22A-22B.

Hagelstein showed that actual energy exchange is possible between the two-level system and a large number of oscillators when loss is introduced to the system e.g. in the form of a damping mechanism that acts on the oscillations.

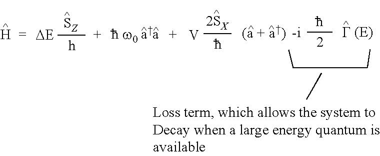

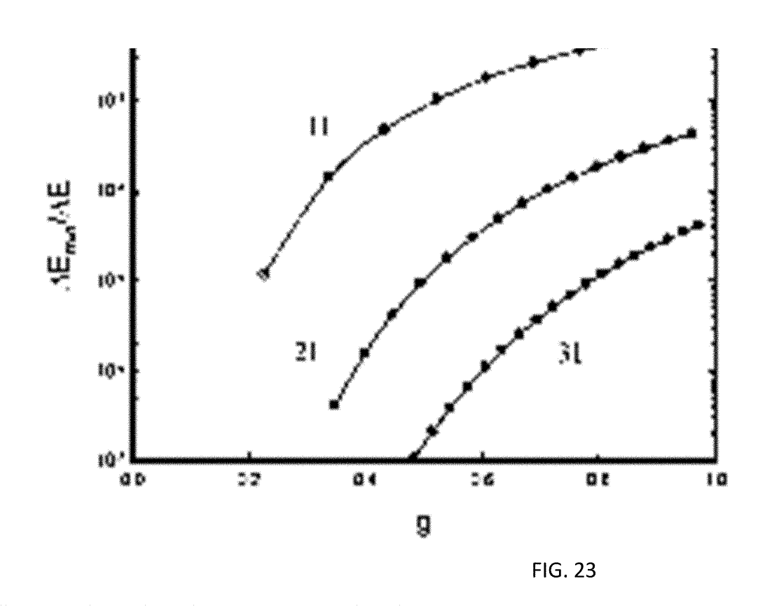

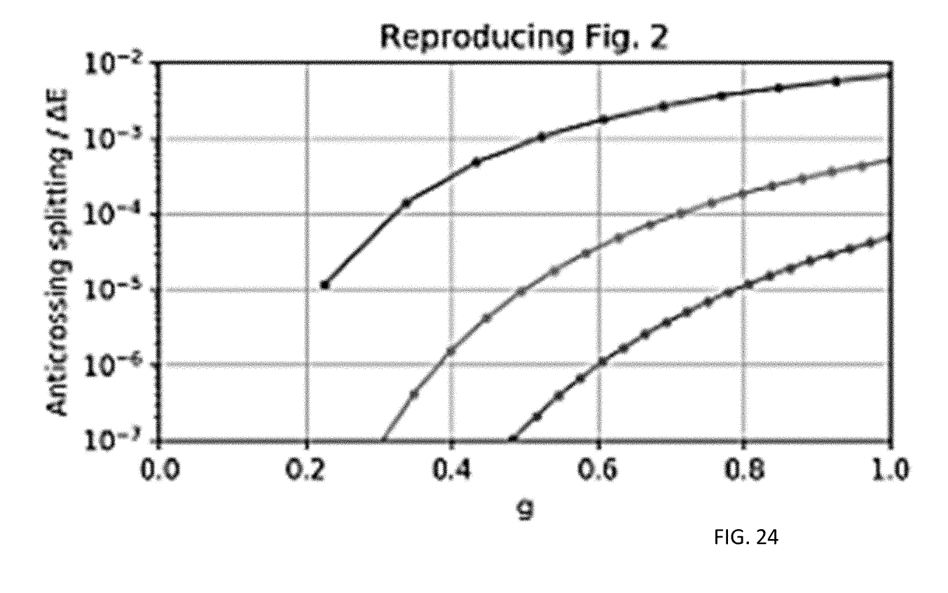

Some of Hagelstein's simulations of the Lossy Spin-Boson Model have recently been independently confirmed. Hagelstein's calculation for feasible levels of energy exchange as a function of coupling constant g are shown in FIG. 23. FIG. 24 shows Byrnes' reproduction of the model and simulation is shown in FIG. 24.

Energy conversion mechanisms based on phonon-nuclear coupling include are utilized by implementations described herein. Phonon-nuclear coupling is a fundamental physical effect that allows for a number of different manifestations of energy conversion between vibrational energy and nuclear potential energy. Macroscopically observed mechanisms include: Excitation transfer (an excited state gets transferred from an existing excited nucleus to a commensurate ground state nucleus via phonon carriers); Up-conversion (a ground state nucleus gets excited from phonons); Down-conversion (energy from an excited state gets converted into phonons); Subdivision (phonons aide in the breakup of a higher energy excited state of a nucleus into several lower energy excited states.

Hagelstein's model development was initially motivated by the desire to understand the possibility of energy exchange between large nuclear quanta (such as the 24 MeV from mass difference in the D+D to He-4 fusion reaction) and phonons. Since this would involve the fragmentation of a large quantum into a large number of small quanta, he called this mechanism down-conversion.

Theoretically, phonon-nuclear coupling is a two-way-street and reports of anomalous X-ray emission in the context of vibrating metals led Hagelstein to investigate the counterpart to down-conversion which he called up-conversion. In up-conversion, a large number of phonons align in order to excite ground state nucleus/transfer their energy to a ground state nucleus.

In Fleischmann & Pons type experiments, large 24 MeV mass defect quantum from d+d to 4He gets down-converted into Millions of sub-eV vibrational quanta. In Karabut, Kornilova & Vysotski experiments, the X-ray energy come from thousands of sub-eV vibrational quanta that pile up to 1.5 KeV and up-convert individual nuclei. Their excited states are short-lived, so they fall back to their ground states, and emit 1.5 KeV X-rays.

Thus, observing up-conversion or down-conversion depends on a considerable number of parameters to be aligned in the right ways. The number of phonons and their energies need to be commensurate to the available nuclear excitation levels; and in addition, the right amount of loss needs to be present in order to prevent destructive interference and being stuck with Ravi oscillations, as suggested by the Spin-Boson Model.

The models suggest that transferring existing excited state energy from excited nuclei to other ground state nuclei with the same energy levels would be “easier” than up-converting or down-converting. A mix of excited nuclei and equivalent ground state nuclei in bulk material (which can carry a large number of phonons) can be created by carefully selecting the samples to be vibrated and the radioactive sources. For instance, Co-57 decays into excited state Fe-57 with nuclear excited states at 14.4 keV and at 136 keV. Iron consists of 2% stable (ground state) Fe-57 which exhibits available nuclear excited states at 14.4 keV and at 136 keV. With the 2% concentration, a large absolute number of ground state Fe-57 atoms are in a macroscopic steel plate sample. The excited state Fe-57 from the radioactive cobalt offers the right amount of energy that the ground state Fe-57 can accommodate. Many of the stable Fe-57 in the plate sample are candidates for excitation transfer—which ones ultimately receive transferred excitation depends on the distribution/generation of phonons across the plate.

Subdivision is another possible energy conversion mechanism based on phonon-nuclear coupling. In this case, higher excited states do not get down-converted all the way down to the level of phonons but instead fragment into several lower energy excited states. If suitable excited states are available, this outcome is more probable than complete down-conversion to phonons. In the presence of phonons, lower energy excited states can then continue to down-convert to even lower excited states or to phonons. Alternatively, lower energy excited states can fall to ground state while emitting photons, as expected in the conventional picture. This is a step-wise approach to down-conversion which is probabilistically favored.

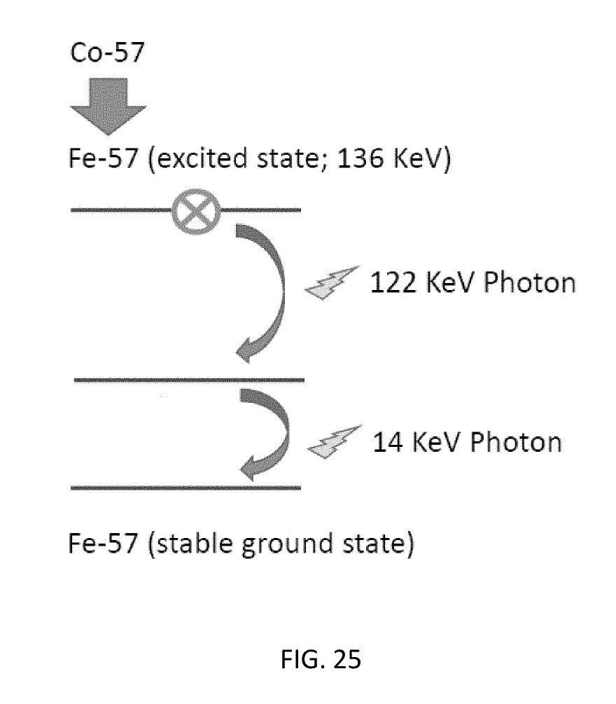

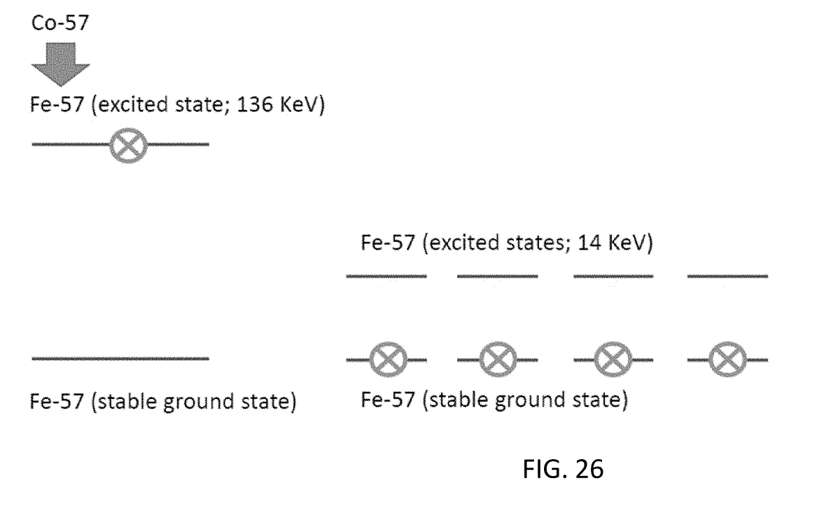

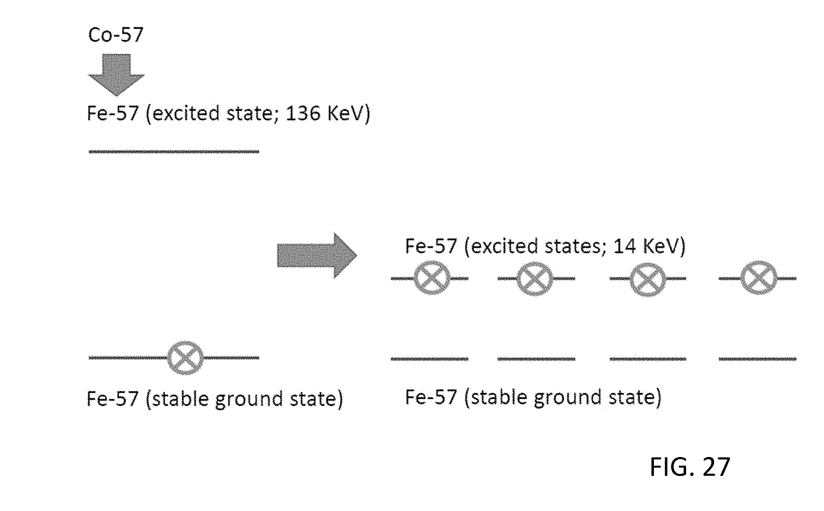

FIG. 25 shows the decay of Co-57 and subsequent de-excitation of populated Fe-57 excited states according to the traditional picture. FIGS. 26-27 show the de-excitation according to a subdivision picture of excitation transfer.

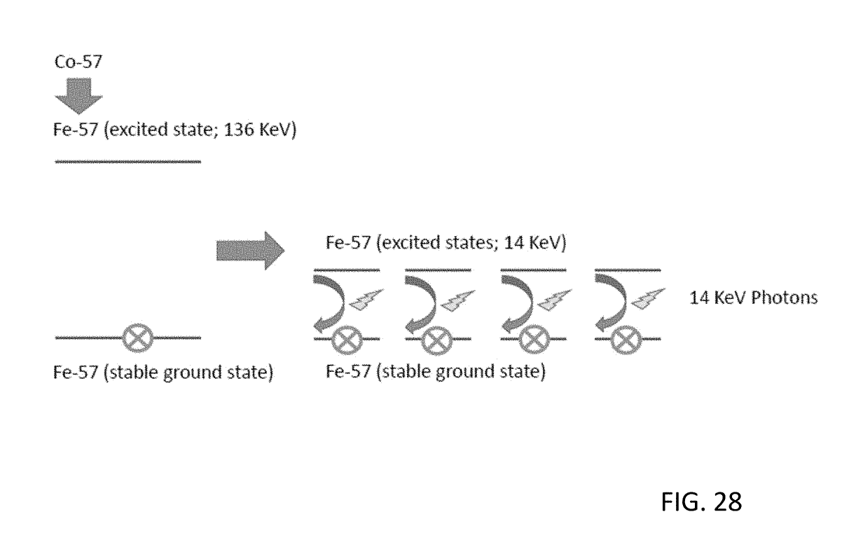

In the scenario of FIG. 28, subdivision would lead to an enhancement of the observable 14 keV line and a commensurate diminishment of the 122 keV line. This can be tested via experiment and measured unambiguously with sensitive high-resolution and sufficiently wide-range spectrometers, for example by use of a liquid nitrogen cooled high purity Ge Gamma detector incoming for that purpose.

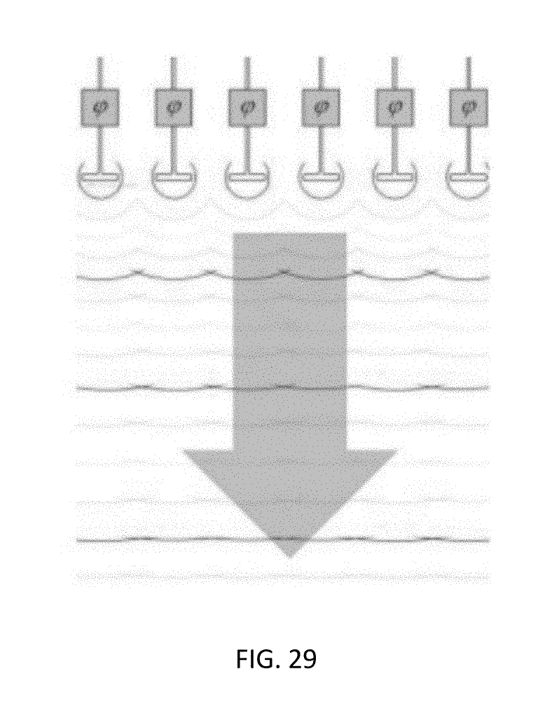

Collimation—Radiation that results from transferred, up-converted, or down-converted excitation, will be collimated. This is highly relevant for designing and interpreting experiment, and for applications. Phonon nuclear coupling requires oscillating nuclei to experience the same vibrational modes so they are aligned in phase. As a consequence, one would predict in-phase excitation of nuclei and collimated emission of radiation, akin to a phased array emitter. See FIG. 29 for an example of an array of dipole antennas that are in phase form a collimated beam.

Collimated X-ray emission is suggested by theory; in addition, it has been observed in Karabut and Kornilova & Vysotskii experiments in association with vibrating steel and alleged mercury impurities. Mercury doped samples can be used for 1.5 keV collimated X-ray emission due to phonon-nuclear coupling.

Phonon generation can be stressed-induced, as in the reported Co-57 implementations, but other methods of phonon generation can be used as well. Implementations described herein are highly relevant to the X-ray lithography industry which depends on low energy, collimated X-rays.

Addendum 3—Some prior published experiments in heat production from supposed nuclear processes without observed correlation with neutrons or other nuclear emissions have been met with skepticism, observations of heat production continue. In some cases, negative findings come from experiments with no calorimetry. A modest number of papers with Pd, D₂O, calorimetry have appeared.

In some recent work, an experiment producing excess heat at high loading is observed to continue producing excess heat when the D/Pd loading is reduced. These and other observations may be understood in view of an understanding of excitation transfer.

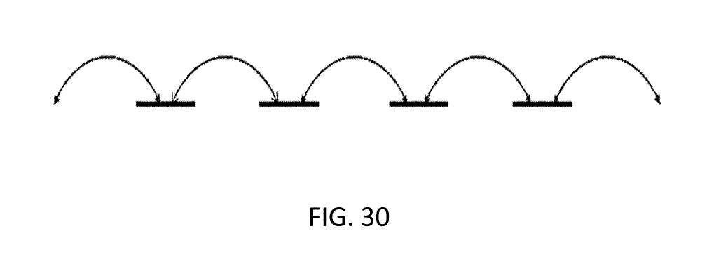

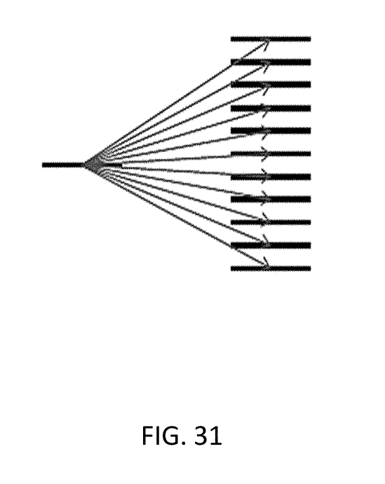

In FIG. 30, a coherent process of excitation transfer from one state to one state or few states is shown, whereas in FIG. 31, an incoherent process of excitation transfer from one state to many states is shown.

In incoherent D₂ fusion, the Coulomb barrier may be tunneled as deuterons tunnel close to each other with small probability for a fast reaction (10⁻²¹ sec) with an energy release of 4 MeV released as kinetic energy. Rate for fusion in D₂ may be too small because of the Coulomb barrier.

The model described herein suggests a need to have vibrations present to initiate down-conversion. A laser beat frequency can be tuned to scan through THz phonon modes.

Modes with low group velocity are expected to be favored. Zero group velocity at G-point (9 THz) and at L-point (16 THz) in PdD may be used. Resonance in excess power may be seen at 8.2 THz, 15.1 THz, also at 20.8 THz (maybe L-point for H impurity). These points support the idea of down-conversion of nuclear radiation.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A method comprising:
energetically inducing an excitation transfer in a nuclear state.

2. The method of claim 1, wherein energetically inducing an excitation transfer comprises energetically stimulating a sample using phonons.

3. The method of claim 1, wherein energetically inducing an excitation transfer comprises heating a structure to which a nuclear species is mechanically coupled.

4. The method of claim 3, wherein heating the structure comprises applying a heat pulse.

5. The method of claim 3, wherein heating the structure comprises generating a stress effect in the structure.

6. The method of claim 5, wherein the stress effect produces vibratory phonons.

7. The method of claim 1, wherein energetically inducing an excitation transfer comprises producing phonons using at least one of a laser, an electric current, and an ion beam.

8. The method of claim 1, wherein energetically inducing an excitation transfer comprises diffusing solutes to produce phonons in at least one of alloys, solids, solutions, and condensed matter.

9. The method of claim 1, wherein the excitation transfer comprises up-conversion.

10. The method of claim 9, wherein inducing the excitation transfer comprises increasing the decay rate of a radioactive species to a rate higher than a natural half-life of the radioactive species.

11. A system comprising:
a support structure;
a sample supported by the support structure; and
a stimulus for energetically inducing, in the sample, an excitation transfer in a nuclear state.

12. The system of claim 11, wherein the stimulus energetically stimulates the sample using phonons.

13. The system of claim 11, wherein energetically inducing an excitation transfer comprises heating the support structure to which a nuclear species in the sample is mechanically coupled.

14. The system of claim 11, wherein the stimulus comprises at least one laser, and wherein energetically inducing an excitation transfer comprises producing phonons using the at least one laser.

15. The system of claim 11, wherein energetically inducing an excitation transfer comprises producing phonons using an electric current.

16. The system of claim 11, wherein energetically inducing an excitation transfer comprises diffusing solutes to produce phonons in at least one of alloys, solids, solutions, and condensed matter.

17. The system of claim 11, wherein the stimulus comprises an ion beam that produces phonons.

18. The system of claim 13, wherein heating the support structure comprises applying a heat pulse.

19. The system of claim 13, wherein heating the support structure comprises generating a stress effect in the structure.

20. The system of claim 19, wherein the stress effect produces vibratory phonons.
